(19) United States
(12) Patent Application Publication
(10) Pub. No.: US 2011/0231320 A1
(43) Pub. Date: Sep. 22, 2011

(54) ENERGY MANAGEMENT SYSTEMS AND METHODS

(76) Inventor: Gary W. Irving, Sterling, VA (US)

(21) Appl. No.: 12/975,188

(22) Filed: Dec. 21, 2010

Related U.S. Application Data
(60) Provisional application No. 61/289,348, filed on Dec. 22, 2009.
(60) Provisional application No. 61/289,351, filed on Dec. 22, 2009.
(60) Provisional application No. 61/289,357, filed on Dec. 22, 2009.

(51) Int. Cl. G06Q 20/00; G06F 1/32; G06Q 50/00; G06Q 30/00; G01K 1/02; G06F 15/00

(52) U.S. Cl. 705/80; 700/291; 705/26.3; 713/300; 702/130

(57) ABSTRACT

Systems, methods and software for energy management; for negotiations and/or auctions between energy aggregators and utility companies.

### RELATED APPLICATIONS

This application claims the benefit of and priority to U.S. Provisional Application Ser. No. 61/289,348 filed on Dec. 22, 2009, U.S. Provisional Application Ser. No. 61/289,351 filed on Dec. 22, 2009, and U.S. Provisional Application Ser. No. 61/289,357 filed on Dec. 22, 2009, the contents of which are hereby incorporated by reference as if recited in full herein for all purposes.

### 1 BACKGROUND

### 1.1 Overview

The inventive subject matter relates generally to systems and software for energy management. An embodiment particularly relates to energy management in buildings and facilities. An embodiment particularly relates to systems, software and algorithms in novel energy management solutions. Certain inventive matter relates to the definition of a novel real world problem resulting from the nexus of energy price trends, major Government initiatives (e.g., Smart Grid), and emerging energy market initiatives such as dynamic utility rates. Certain inventive matter describes a novel approach for a solution to this new novel problem in building energy management. A novel approach is based around unique advancements in meta-heuristic optimization algorithms specifically tailored to the unique challenges of the modern building energy management problem. A solution implementation will leverage emerging communication standards at the building level and internet communication with a central web site where the novel optimization algorithms will be stored and run. Energy management solutions described in this submittal is equally applicable for all types of buildings including but not limited to: single family homes, apartment buildings, office buildings, commercial retail buildings including malls, schools, hospitals, prisons, industrial buildings including factories and Government buildings including military bases.

### 1.1.1 Nexus of Conditions Defines Unaddressed Problems

The first decade of the 21^{st} century has witnessed a number of significant trends that promise to accelerate in the second decade. These trends include rising energy prices in general, rising cost of energy for building/facility operations and responses of the U.S. Government and the North American energy industry to these trends. The major industry response is to solicit State approval for dynamic (in some cases real-time) utility energy rates and build the infrastructure to implement and manage real-time utility rates. This environment thus defines a unique energy management problem for the building owner/operator. One that is large (hundreds to thousands of control, status and input dimensions), complex (building energy dynamics is best modeled by complex differential equations), stochastic (e.g., uncertainties regarding the near term weather), multi-objective (e.g., reflecting value tradeoffs between cost of energy consumption and comfort/convenience of building usage) and dynamic (e.g., the Utility Company can and will change their rates in real time). This combination of problem factors is new and novel as a result of recent emerging market and industry trends.

### 1.1.2 Nexus of Maturing Technologies Creates Opportunity for New Novel Solutions

A major nexus of energy demand, energy supply, national policy and enabling technologies and standards has occurred concurrent with the timeframe of this submittal. Rising energy costs and an aging electricity distribution network have motivated the launch of a major Government-Corporation (public-private) collaboration—the Smart Grid. At the same time emerging technologies such as Advanced Metering Infrastructure (AMI) provide enabling building blocks for the submitted novel approach. Enabling communication standards allowing new smart appliances to be remotely controlled and send status information to email addresses are reaching maturity. These are technology building blocks which provide much of the overall solution for smart building energy management. What is missing is the adaptive intelligent decision making algorithms and software and related hardware systems to manage all the new technology building blocks.

### 1.2 Housing Energy Cost Trends

Energy costs have seen dramatic growth in this decade. Every building owner or user needs to conserve on energy usage and reduce costs. Sources of energy, whether it is the local electric company or a gas generator connected to the building produces some level carbon dioxide into the environment causing pollution and contributing to global warming. FIGS. 1-5 show background information on building ownership and energy usage. These FIGs as based on Federal Government data clearly establish:
Building energy consumption is a major component of National energy consumption (FIG. 1),
The majority of home energy consumption resides in a handful of major appliances such as HVAC and water heating (FIG. 2),
Total commercial building energy consumption has risen steadily since 1990 (FIG. 3),
Energy consumption per square foot of office space has risen sharply in the last two decades (FIG. 4), and
The majority of ownership by percent of floor space is commercial ownership (FIG. 5).

### 1.3 Smart Grid

The Department of Energy through its Office of Electricity Delivery and Energy Reliability has formed the multi-agency Smart Grid Task Force. The Smart Grid represents a once in a Century commitment by the US Federal Government to modernize the national electricity delivery grid and put it under digital control for improving efficiency, reliability, robustness, environmental friendliness and improve economic competitiveness. A number of features of the Smart Grid are relevant to this application. The Smart Grid will facilitate two-way flow of electricity and information regarding electricity consumption. This will open up markets for trading of electricity and provide the consumer with the information they have never had before—their ongoing consumption of energy. This last feature is crucial to opening up a more real time relationship between the consumer and the Utility Company. The Utility Company will have the ability to offer real time or time-differentiated rates and the consumer will have the ability to manage their energy consumption in a fashion to leverage the varying rates from the Utility Company. However, consumers are not interested in sitting around their houses constantly managing how their house uses energy. What they will do is spend two hours per year to set their comfort, price and environmental preferences, thus enabling their collaboration with the grid to occur automatically on their behalf and saving money each time. This application addresses a novel approach to facilitating the automation of the consumers' preferences in their collaboration and negotiation with the Utility Company.

### 1.4 Advanced Metering Infrastructure (AMI)

An emerging technology necessary to enable this new communication relationship between Utility Company and electricity consumer is Advanced Metering Infrastructure or AMI. AMI consists electricity meters that measure and record usage data at a minimum in hourly intervals and provide this usage data to both consumers and utility companies. A number of companies (e.g., GE's SmartMeter) have built and deployed such AMI devices that make energy consumption data available by wireless and WIFI means via standard protocols. New business models will be enabled by Smart Grid technology. Aggregators that represent large numbers of energy consumers will handle the complex real time rate negotiations or auctions with the utility companies. A novel approach to enable the Aggregators and their subscribing consumers' ability to have their comfort, cost and environmental preferences in a flexible, automated fashion is presented in this application.

### 1.5 Smart Devices and Demand Response

Another emerging technology is that of smart energy consuming devices that can be turned off or have their energy consuming state managed remotely. For example a smart air conditioner can communicate directly with the Utility Company. If the user chooses to participate in an opt-in program that turns control of the air conditioner directly to the Utility Company, the consumer will get a rate discount. This relationship is called “Demand Response” in the emerging Smart Grid world. The Utility Company wants to manage peak demand and the consumer wants to manage annual costs through lower rate structures, so the relationship offers a response to demand or “Demand Response”. The Standards Body OASIS has started an initiative call OpenADR to facilitate communications standards for Demand Response.

### 1.6 Standards

There are a number of Standards efforts underway at the time of this application that will provide the interoperability standards to facilitate the communication from the individual energy consuming device in the building through a building/campus network and Aggregator system through the internet/cloud to a multi-building Aggregator (as an embodiment proposed by this application) to the Utility Company and back down again. These standards include the following activities:

1. Building Device Level Control and Integration Including AMI Meters
a. OpenADR—direct load control
b. BACnet—
c. OpenHAN—Home Area Network Device communications, measurement and control
d. ZigBee/Home Smart Energy Profile—HAN device communication and information model
e. OpenLynx—Open Source Initiative for Integrated Building Automation Systems (BAS)

2. Interoperability Between the Building and the Smart Grid Supporting ADR
a. BACnet—Load Control Object
b. ZigBee—Load Control and Price Cluster
c. OpenADR—supports real-time price rates to the building and direct load control
d. IEC 61850—common information model
e. ANSI C12.19—revenue metering information model

3. Networked Devices within a Building or Integrated Campus of Buildings
a. TCP/IP
b. DHCP
c. TELNET
d. SNMP
e. SSL

4. Networking from Buildings to Aggregators or Central Service Sites
a. HTTP
b. Web Services—SOAP, WSDL, DPWS (WS-Discovery, WS-Eventing), WS-MetadataExchange
c. XML Extensions and Applications
d. IPv4, IPv6

5. Major Standards Initiatives
a. NIST—coordinate the development of a framework for interoperability of smart grid devices and systems
   i. Development of Standards Roadmap
   ii. Release of initial standards lists
b. OASIS
   i. UPnP
   ii. DPWS

### 1.7 Prior Patents

As background relating to optimization techniques, U.S. Pat. No. 4,873,649, shows a Lagrangian method of zeroing partial derivatives and is hereby incorporated by reference in its entirety for all purposes. US 2005/0192680 shows use of fuzzy logic, meta-heuristic algorithms, and neural networks and is hereby incorporated by reference in its entirety for all purposes. A third reference, WO 2007/128783 discloses techniques such as gradient descent, Tabu search, Bayesian Belief Networks, Self-Organizing Maps, ReliefF, neural networks, meta-heuristic algorithms, and fuzzy logic and is hereby incorporated by reference in its entirety for all purposes.

As background relating to real-time pricing, U.S. Pat. No. 5,924,486 is hereby incorporated by reference in its entirety for all purposes.

Regarding temperature management, US 2008/0277486 incorporates individual temperature sensors and air flow volume controls for each zone and is hereby incorporated by reference in its entirety for all purposes. The heat load of each room is calculated so the air flow volume controls can offset and equivalent volume of cool air. This assumes the air is held at constant temperature and that the flow rate is not dependent on pressure. This may be true in oversized HVAC systems. However, in right-sized or home systems, this is likely not the case.

Regarding weather forecasting U.S. Pat. No. 6,098,893 is hereby incorporated by reference in its entirety for all purposes.

Regarding computational modeling, US 2007/0005191 teaches eliminating room load calculation from the model to increase calculation speed and is hereby incorporated by reference in its entirety for all purposes. However, this oversimplified model does not work in combination with fine-grained climate control. U.S. Pat. No. 5,467,265 uses a static model rather than dynamic programming because dynamic programming is too computationally expensive and is hereby incorporated by reference in its entirety for all purposes. U.S. Pat. No. 5,115,967 indirectly learns the heat transfer rate between walls by measuring the heat loss of the home as a whole, but it does not perform room-by-room heat modeling and is hereby incorporated by reference in its entirety for all purposes.

Another reference US 2008/0277486 measures individual heat sources within the room to calculate how much additional cooling is necessary to offset the heating due to human metabolism, human activity, and heat-producing appliances within the building. This reference also measures the temperature of each room. US 2008/0277486 is hereby incorporated by reference in its entirety for all purposes.

An additional reference US 2005/0234596 is hereby incorporated by reference in its entirety for all purposes and allows entry of data related to thermal coupling of the room to the outside. However, this does not teach controlling room-by-room temperature prediction, merely predicting aggregate demand. In addition, because of modern availability of sensors with more computational ability, decreases in sensor cost, and increasing availability of sensor communication protocols, it is against well-known design considerations to rely on room-by-room model predictions rather than using actual sensors.

Regarding control of individual heat registers, U.S. Pat. No. 4,407,447 is incorporated by reference in its entirety for all purposes. US 2005/0192680 discloses variable dampers to control air flow, but does not disclose wireless control. US 2005/0192680 is incorporated by reference in its entirety for all purposes. US 2008/0277486 discloses wireless zone ventilation devices and is incorporated by reference in its entirety for all purposes.

Regarding control of appliances, U.S. Pat. No. 6,263,260 gives an example of controlling a hot water heater schedule and is incorporated by reference in its entirety for all purposes. U.S. Pat. No. 6,633,823 discloses remote deactivation of electrical loads and is incorporated by reference in its entirety for all purposes. U.S. Pat. No. 7,181,293 manages energy states for a variety of home appliances and devices including air conditioning, hot water heater, and a television and is incorporated by reference in its entirety for all purposes. US 2003/0171851 discloses a round-robin curtailment system to avoid brownouts where individual loads are classified into groups for disabling to shed loads and is incorporated by reference in its entirety for all purposes. US 2006/0271214 disclose smart appliances, which can report usage data and is incorporated by reference in its entirety for all purposes. US 2006/0038672 suggests managing electrical usage at the plug for devices in unused rooms and is incorporated by reference in its entirety for all purposes.

Regarding assembling an initial parameter database for seeding a computer model and selling or renting such a database, US 2007/0005191 incorporates an optimization preprocessor, which loads historical weather norms and building specifics and is incorporated by reference in its entirety for all purposes. US 2005/0234596 discloses using parameters from other buildings in a system of the same type as input variables to the model and is incorporated by reference in its entirety for all purposes. U.S. Pat. No. 4,475,685 discloses optimizing start and stop time for an HVAC system using an algorithm that will converge more rapidly on an optimum solution when populated by an educated guess from a skilled human and is incorporated by reference in its entirety for all purposes.

Regarding a discrete learning phase and additional sensors present during the discrete learning phase, US 2006/0038672 discloses adding or subtracting sensors at any time and is incorporated by reference in its entirety for all purposes. US 2005/0234596 discloses relatively autonomous sensors incorporating local CPU, storage, and IP-addressable networking and is incorporated by reference in its entirety for all purposes.

Regarding sharing data with nearby buildings, US 2005/0234596 teaches the use of parameters from adjacent buildings in a similar microclimate as inputs to the model and is incorporated by reference in its entirety for all purposes.

There are two categories of similar but different solutions that are not optimal as they only consider optimization of the energy management of a single building and that don't include variable rates from the Utility Company in the optimization search space. The first category includes solutions from large companies that manufacture some of the energy consuming devices in buildings such as HVAC equipment. These companies have offered more sophisticated controls of these equipments in recent years but they only control the energy consumption management of the equipment manufactured by that Company as opposed to all the energy consuming devices in the typical commercial or domestic building. Even these energy consumption control systems are not predictive in that they do not consider weather forecasts, building usage patterns or varying energy cost charge patterns by time of day.

The second category of similar but different solution comes from a number of new entrants (solutions are in pilots, not yet offered to the market) to the building energy management arena. These similar but different solutions aim to control all major energy-consuming devices in a building but they rely on the user/manager to make difficult decisions in determining the device management rules and algorithms via GUIs, a tedious and error prone approach at best. These solutions will tax user/managers who will likely become frustrated in trying to solve with complex energy management problems. At the same time, after extensive investment of time from the building user/managers the energy management solutions developed by them will be suboptimal and inflexible and will neither accomplish the targeted energy cost savings nor the targeted comfort zones. Finally, this approach does not build a knowledge base upon which subsequent users may accelerate their building-specific modeling and energy consumption optimization.

The foregoing discussion illustrates just some of the disadvantages and problems in the area of energy management and optimization for buildings and facilities and is not intended to be an exhaustive list of all problems that can be addressed by the various embodiments of the inventive subject matter disclosed or contemplated herein.

### 1.8 Description of an Approach According to the Inventive Subject Matter

To address the aforementioned needs and problems, the inventive subject matter provides a body of solutions related to improved energy management systems and methods.s. In light of the growing building energy consumption crisis, it would be desirable to have an energy-management architecture with associated software that would automatically and remotely manage the energy consuming devices in a building. Furthermore, it would also be desirable to have a system and software that would manage the energy consuming devices in a building in a fashion that minimized cost while provided the necessary living or working environment for the inhabitants. Still further it would be desirable to have a system and software that would manage the energy consuming devices in a building unattended through all weather conditions, dynamic energy cost structures and dynamic building usage scenarios. Therefore, there currently exists a need in the industry for a system that automatically manages and optimizes building energy consumption. Embodiments of inventive subject matter presented herein describe novel combinations of algorithms, software, processing hardware, sensors, control devices, communication channels/protocols built around enabling unique meta-heuristic optimization algorithms and auction/negotiation algorithms tailored to solve the building energy management challenge.

### 2 SUMMARY

These and other embodiments are described in more detail in the following detailed descriptions and the Figures.

The solutions and advantages of the various embodiments of inventive subject matter disclosed herein include, but are not limited to:
Reducing building energy operating costs to a minimum, subject to:
Maintaining an acceptable interior environment with regard to comfort, convenience and productivity;
With a minimum of up front investment in energy management equipment and licenses;
A minimum of up front time and inconvenience in the installation and set up of the building energy management solution;
A minimum of cost in the operation of the energy management solution;
A solution that operates automatically without requiring real time decision making from the building owner or occupants; and
To provide a robust and adaptive building energy management solution that either anticipates or responds rapidly to changes in external weather, internal building state, usage preferences of occupants, operating characteristics of energy consuming appliances/devices, market cost of energy and real-time utility rates without requiring the constant intervention of the building owner or occupant for effective energy management.

The inventive subject contemplates the following possible embodiment: a computer-implemented method of managing energy usage using a general purpose computer programmed with particular software for performing the steps comprising: identifying a plurality of n energy loads to be managed; simulating an n-dimensional configuration space comprising a control vector for each energy load based on a comfort/cost tradeoff curve for each energy load and a current cost structure; locating an optimized control n-vector in the n-dimensional configuration space based on aggregate comfort/cost; and wherein all preceding steps are executed on a computer. In the foregoing embodiment, the method may further comprise: characterizing the plurality of energy loads using a best-fit load profile selected from a plurality of aggregate load profiles comprising a set of rules for calculating an initial value for each load; and wherein the locating an optimized control vector comprises a recursive optimization method using an initial n-vector based on the plurality of best-fit load profiles for each energy load. In the foregoing embodiment, the method may further comprise: calculating the comfort/cost tradeoff. In the foregoing embodiment, the method may further comprise: curve using latent variable model. In the foregoing embodiment, the latent variable model may comprise answers to yes/no questions as manifest variables.

Another possible embodiment contemplates a computer-implemented method of forecasting energy costs using a general purpose computer programmed with particular software for performing the steps comprising: identifying, on a computer, a plurality of energy loads, each energy load having a maximum energy usage and a cost for every level of energy usage between zero and the maximum energy usage and the plurality of energy loads having an a maximum aggregate energy usage; simulating a cost/usage probability surface comprising a probability of a given cost for a given level of energy usage by the energy load for from zero to the cost of the maximum energy usage based on the current rate structure; and wherein all preceding steps are executed on a computer. In the foregoing embodiment, the method may further comprise: calculating a cost/comfort probability surface based on a comfort/cost tradeoff curve for each energy load on the computer for costs less than the maximum cost and a maximum likely cost for each load using the cost/usage probability surface based on a given a confidence level of probability and the maximum usage; simulating an n-dimensional configuration space comprising a control vector for each energy load using the computer; and locating an optimized n-vector in configuration space based on the cost/comfort probability surface using the computer.

In another possible embodiment, the inventive subject matter contemplates a computer-implemented method of managing energy usage using a general purpose computer programmed with particular software for performing the steps comprising: identifying a plurality of n energy loads to be managed on a computer, each energy load having a comfort curve for each energy load on the computer comprising one or more dynamic variables; calculating a predicted comfort/cost curve based on a predicted probability distribution for each of the n energy loads; simulating an n-dimensional configuration space comprising a control vector for each energy load using the computer; and identifying an optimized n-vector in configuration space based on the predicted comfort/cost curve; and wherein all preceding steps are executed on a computer. In the foregoing method, there may be two or more dynamic variables and at least one of the dynamic variables is not linearly independent of the other dynamic variables.

In another possible embodiment the inventive subject matter contemplates a computer-implemented method of building a comfort/cost curve using a general purpose computer programmed with particular software for performing the steps comprising: identifying a plurality energy loads to be managed, each energy load having one or more control parameters that affect energy usage, one or more output parameters that affect comfort, and a comfort/cost tradeoff curve; simulating an n-dimensional configuration space comprising a control vector for each energy load using the computer; identifying an optimized position in the configuration space based on aggregate comfort/cost; and wherein all preceding steps are executed on a computer.

In another possible embodiment the inventive subject matter contemplates a computer-implemented method of managing energy usage using a general purpose computer programmed with particular software for performing the steps comprising: identifying a plurality of n energy loads to be managed; simulating an n-dimensional configuration space comprising a control vector for each energy load based on a comfort tradeoff curve for each energy load and an aggregate cost structure based on total usage; locating an optimized control vector in the n-dimensional configuration space based on aggregate comfort/cost; and wherein all preceding steps are executed on a computer. In the foregoing embodiment, the method may further comprise: outputting the optimized control vector to each individual load wherein the load implements the portion of the control vector. In the foregoing embodiment the n-dimensional configuration space further comprises a control vector for one or more devices that do not impose an ongoing energy load but affect comfort. In the foregoing embodiment, the one or more devices do not impose an ongoing energy load but affect comfort comprises a heating register.

In the foregoing embodiments a plurality of n energy loads may be physically located in a single structure. In the foregoing embodiments a plurality of n energy loads are physically located in different structures.

In another possible embodiment of the inventive subject matter, method for a two party negotiation between aggregator and utility, comprises determining bids based on an aggregator's assembled user resource allocation limitation preferences as modified by aggressiveness factors. The foregoing embodiment may further comprise multiple back and forth bids and counter bids between aggregator and utility.

Another possible embodiment of the inventive subject matter contemplates a method comprising performing an auction (one way auction) wherein there are multiple aggregators' bids, wherein the auction is based on respective assembled user resource allocation limitation preferences modified by aggressiveness factors; and wherein bids are calculated to meet or exceed contract terms for their respective demand compliance agreements with utilities. In the foregoing embodiment the auction may have one aggregator and two or more utilities. In the foregoing embodiment the bidding may be automatic. In the foregoing embodiment, the bidding may be “owner decision” bidding utilizing direct communication with user. (text, phone, email, user interfaces on energy devices, etc). In the foregoing embodiment, the auction model may be based on a VCG model with a balanced budget option. In the foregoing embodiment, the VCG model is computed on a central computer.

In any of the above methods the negotiations or auctions may be time structured meaning that the process is repeated on a regular time increment. In the methods time increment may be between about one hour, or one hour and 72 hours or weekly or monthly or yearly. In the methods aggregators may bid with two or more utilities. (two way auction). In the methods, the aggregator may allocate savings resulting from successful bids to user based on user's aggressiveness factor.

The inventive subject is not limited to methods; it also contemplates machine executable instructions stored on computer readable medium (i.e., software) for carrying out the methods described or contemplated herein and hardware systems and devices disclosed herein embodying the software, or controlled by or controlling systems and devices embodying such software.

The foregoing is not intended to be an exhaustive list of embodiments and features of the inventive subject matter. Nor is it intended to represent the only permutations of inventive combinations of features. Persons skilled in the art are capable of appreciating other embodiments and features from the following detailed description in conjunction with the drawings.

### 3 BRIEF DESCRIPTION OF DRAWINGS

Representative embodiments according to the inventive subject matter are shown in the following detailed description and Figures.

FIG. 1 shows a graph of the share of aggregate energy consumption by buildings, industry, and transportation categories.

FIG. 2 shows a graph of home energy consumption by device or application.

FIG. 3 shows total commercial building energy consumption in the United States from 1990 projected to 2010.

FIG. 4 shows energy consumption per square foot of office floor space by building vintage.

FIG. 5 shows building ownership by percentage of floor space.

FIG. 6 shows one embodiment of an energy management system using a corporate Website, a home PC, and managed appliances.

FIG. 7 shows one embodiment having both a local processor and a corporate Website and illustrates aspects of the relationship between the two.

FIG. 8 shows several designs for vane patterns for flue registers.

FIG. 9 shows the relationship between the different algorithms in one embodiment of the energy management system and software.

FIG. 10 depicts a multi-building instance of the approach and shows the relationship between the Central Corporate Website, participating buildings (by type) and the Utility Company.

FIG. 11 shows the flow of implementation and operation for a multi-building instance including the two-way auction role in the demand-response negotiations.

FIG. 12 shows particle swarm agents with communicating neighborhoods.

FIG. 13 shows the algebraic operators that influence the positions and velocities of the agents in a PSO application.

FIG. 14 shows the influence of the communicating agents on a given agents position and velocity in a PSO application.

FIG. 15 shows the “moving peak” problem in PSO application resulting from weather drift and Utility Company rate actions.

FIG. 16 shows the vector arrangement of the swarm in the Irving-wolfhound version of PSO.

FIG. 17 shows the basic velocity geometry for a lead angle pursuit approach in a classical predator-prey problem.

FIG. 18 shows the various strengths in ant trails in an Ant Colony Optimization in an ACO application.

FIG. 19 shows relationship of data flow, algorithms and models in placing a new building into an archetype for seeding a learning model.

FIG. 20 shows the profile of target temperature for a hot water heater throughout an energy managed day.

FIG. 21 shows the relative positions of remote controlled air flow vents in various rooms through an energy managed day.

FIG. 22 shows the data flow and relationship of algorithms/models in implementing a demand response negotiations approach for a multi-building instance.

FIG. 23 illustrates a two way auction between the participating buildings and an Aggregator on one side and the Aggregator and the Utility Company on the other side.

FIG. 24 shows a peak energy demand smoothing.

FIG. 25 shows a comfort value function for a single room temperature.

FIG. 26 shows contributions of individual buildings to time-shifting of the peak energy demand curve.

FIG. 27 shows a Swimlane flowchart for an initial single building energy management system setup.

FIG. 28 shows a Swimlane flowchart for a definition of building-specific energy dynamics model.

FIG. 29 shows a Swimlane flowchart for an embodiment of energy management optimization.

FIG. 30 shows a Swimlane flowchart for an embodiment of energy management operations.

FIG. 31 shows a Swimlane flowchart for an embodiment of energy management improvement for a single building.

FIG. 32 shows a Swimlane flowchart for an embodiment of demand response auction and negotiations between Aggregator and Utility Company.

FIG. 33 shows a general PC for use in embodiments of the inventive material.

FIG. 34 shows the infrastructure for a series of remote controlled air flow vent registers under the control of a single micro-processor

FIG. 35 shows the user interface design and display for a re-locatable wireless temperature sensor or thermostat

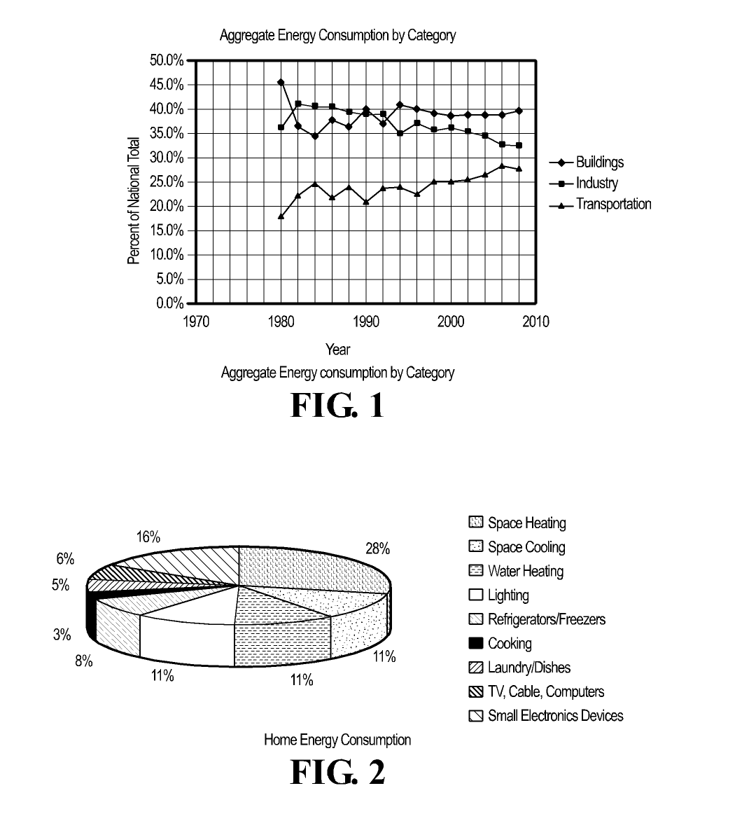

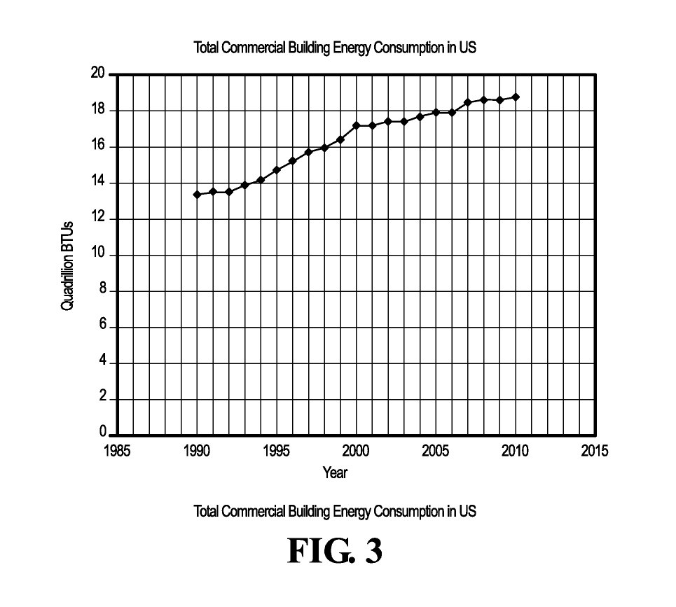

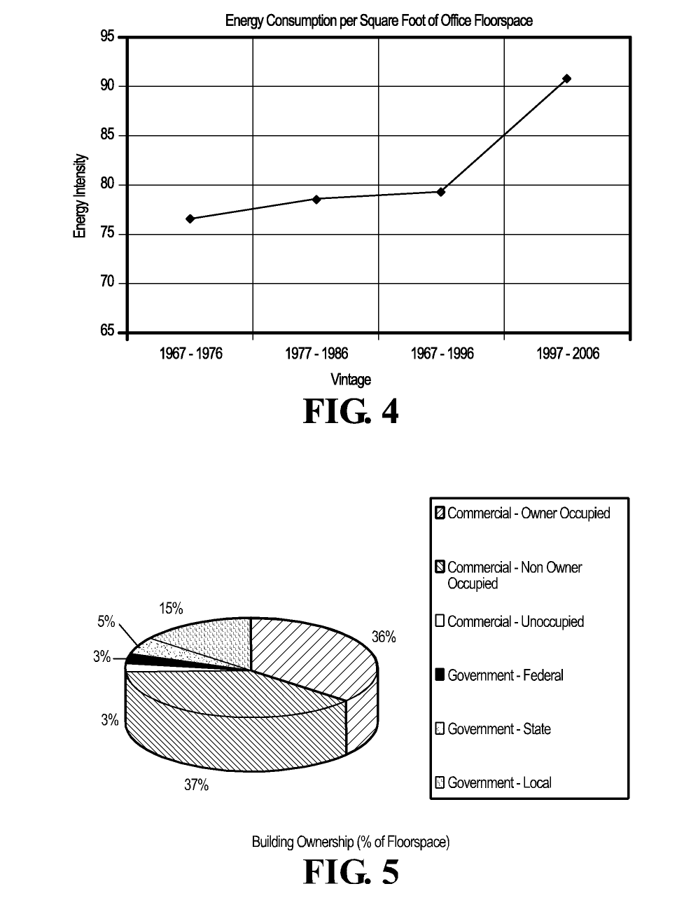

### 4 DETAILED DESCRIPTIONS

### 4.1 Summary Overview of Certain Implementation Embodiments

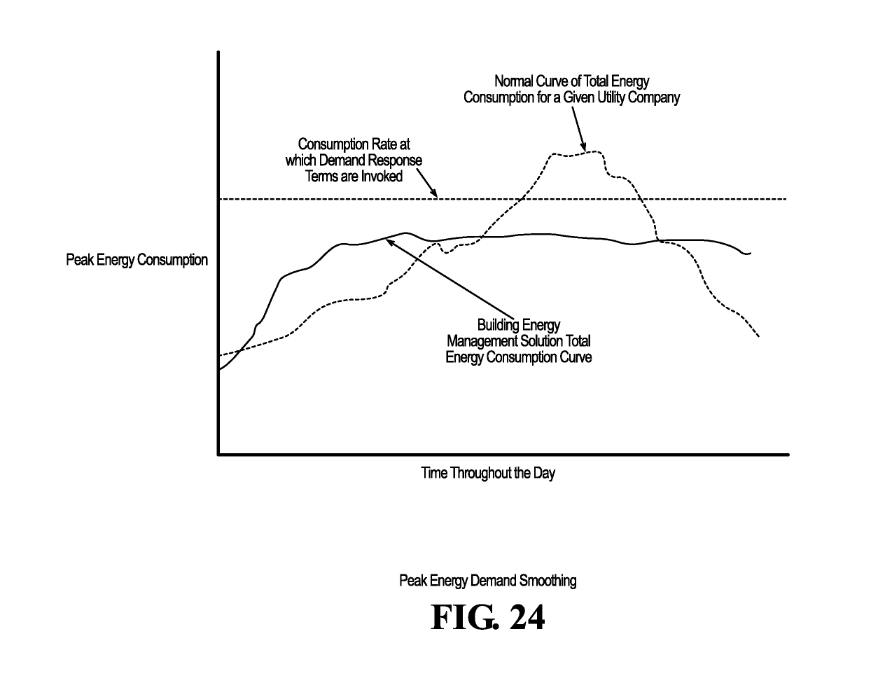

An illustration of the possible change a building energy management solution may effect in total energy consumption is shown in FIG. 24. This Figure shows aggregate energy consumption throughout a typical day by all buildings supplied by a given Utility Company. The normal curve is shown in a dashed gray line. A dotted black line shows a possible level of the aggregate energy consumption at which a Utility Company would invoke its demand response contractual terms and expect buildings to comply by consuming less energy (e.g., shut something off). One goal of a building energy management solution is to avoid the Utility Company invoking its Demand Response terms. This may be accomplished, in part, by time-shifting the energy demand of the participating buildings. This is shown by the solid black line in FIG. 24. An example would be moving the use of washers and dryers from late afternoon to morning. Since air conditioners often peak in later afternoon, the movement of the use of washers and dryers would avoid a usage collision and thus contribute to lowering the peak energy consumption. This process is known as smoothing the peak demand curve.

### 4.1.1 Definition of a Novel Problem Addressed by the Inventive Subject Matter

Meta-heuristic methods are often applied to minimize or maximize functions called utility functions representing a goal or value of the desired result. In this document such functions will be called “value functions” instead of “utility functions” because of other uses of the word utility referring to electric companies and their respective rates they charge their customers.

The goals and objectives, when translated into more formal definitions, define a significantly complex and novel optimization problem wherein the value function and search space of which may be characterized by some or all of the following:
Hybrid optimization space consisting of discrete (e.g., turning a device on or off, the Utility Company applying “peak demand” rates or not, etc.) and continuous variables (temperature in the living room),
Extremely high dimensionality as represented by all the potential devices/appliances that could be turned off or put in reduced energy consumption mode by all the building owner/operators who participate in the aggregate negotiations with the Utility Company in order to support Demand Response,
Dynamic optimization problem in that major variables such as the weather, ongoing aggregate energy consumption, dynamic rates from the Utility Company are all changing over time,
Stochastic in that all of the dynamic variables are not the result of mechanical systems and thus can only be forecasted within certain statistical bounds, for example:
   The weather—temperature, precipitation, etc. by geographic subzone,
   The Demand Responses of those buildings supported by the Utility Company but not subscribers to this solution,
   The actual Demand Responses (the solution likely will offer emergency overrides to its subscribers) from those buildings participating in the aggregate negotiations with the Utility Company,
   Which Demand Response offers the Utility Company will actual accept,
   The actual time and value of the peak demand,
Multi-Objective Value Function considering the tradeoffs between lifestyle comfort of each building, energy operating costs of each building, aggregate Demand Response over all subscribers and resulting cost structure from the Utility Company, and
Over an Integral of Time the optimization method needs to search for the best solution aggregating the points of the value function through the course of a complete 24 hour day for each building.

### 4.1.2 Elements of an Approach

Elements which may be used in the various embodiments of inventive subject matter disclosed here may be broken into three segments:
Technology elements installed within the building (and owned or leased by the building owner or occupant),
Technology elements installed at a central web site and corporate data center, and
Technology elements owned by the Utility Company.

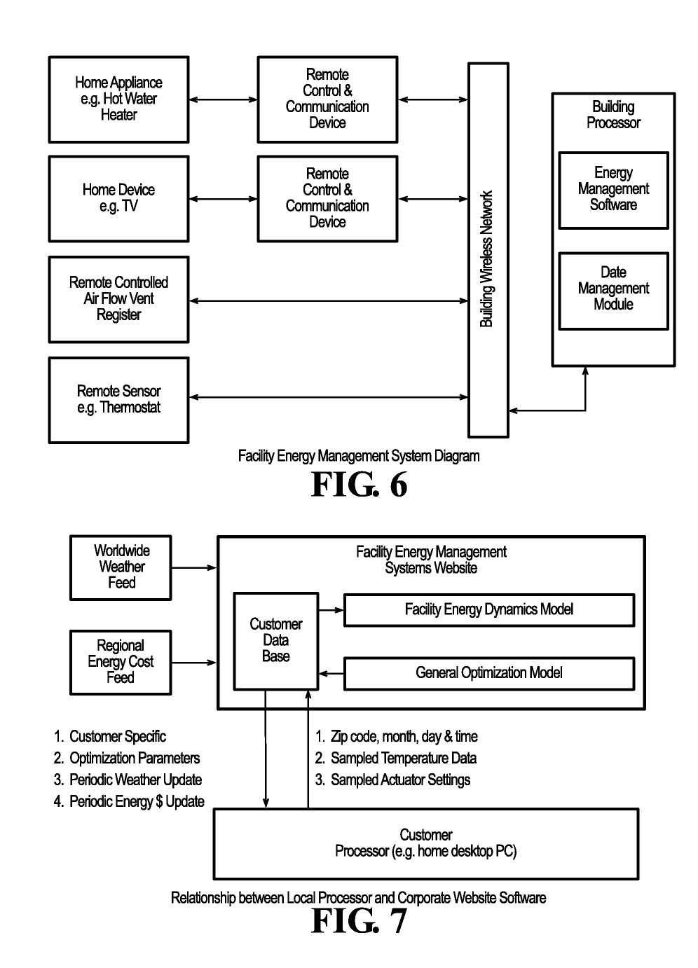

The technology elements installed within the building (depicted in FIG. 6) may include:
Energy consuming appliances (e.g., hot water heater) and devices (e.g., TV),
Remotely controllable instruments on energy consuming appliances and devices (might be retrofit to enable the energy management solution),
Remotely communicating sensors (e.g., thermostats),
Local processor (e.g., home desktop or laptop computer),
Building energy management software installed on local processor,
Building based communication network (e.g., wireless),
AMI energy consumption meters (might be owned by the Utility Company and installed on the building), and
Building based internet access.

The technology elements installed at the central web site and data center may include:
High bandwidth internet access
Servers
Large Dynamic Storage (e.g., SAN)
Energy management software for all buildings managed
Demand Response negotiation software
Access for streaming data feeds such as weather data and utility rate data

The technology elements owned by the Utility Company may include:
Central web site and data center,
Servers,
Infrastructure for gathering AMI data,
Software for tracking energy consumption and managing real time utility rates, and
Software for demand response negotiations with individual buildings or their Aggregator representatives.

### 4.1.3 Additional Implementations

There are a number of specific novel implementations of the aforementioned approach. One embodiment includes installing the building energy management system locally with software loaded by CD-ROM or DVD with no interaction from a central web site and no demand response relationship with the Utility Company. This would represent a lower cost and less effective implementation, but still likely to have a positive return on investment for most buildings. This installation may be expanded with an interaction with a central web site (shown in FIG. 7) for a number of advanced features such as, but not limited to, live weather feed, regular optimization software updates, etc., but still with no demand response relationship with the Utility Company. This somewhat more advanced implementation version may be further enhanced with a demand response relationship with the Utility Company facilitated on a single building basis.

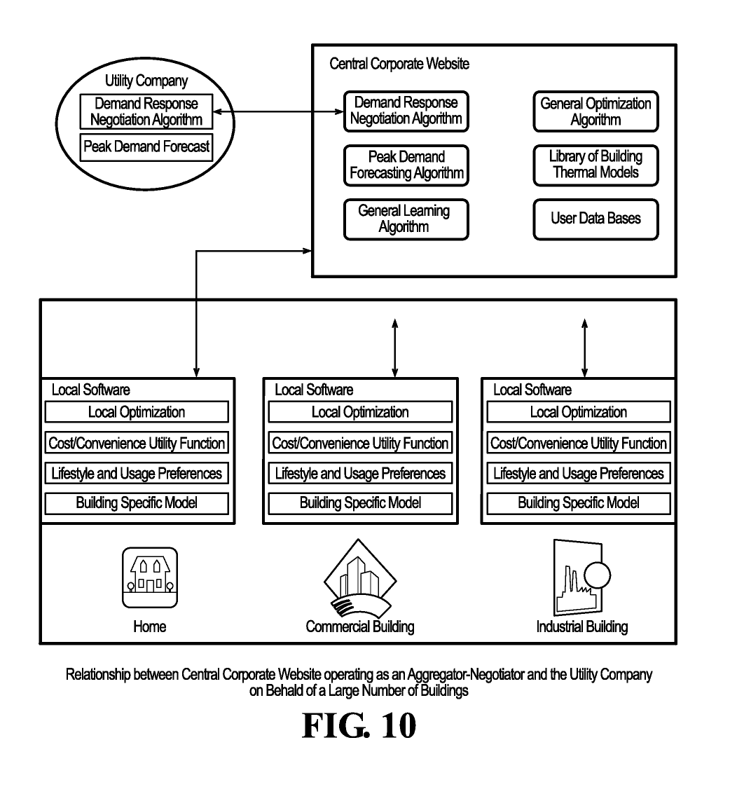

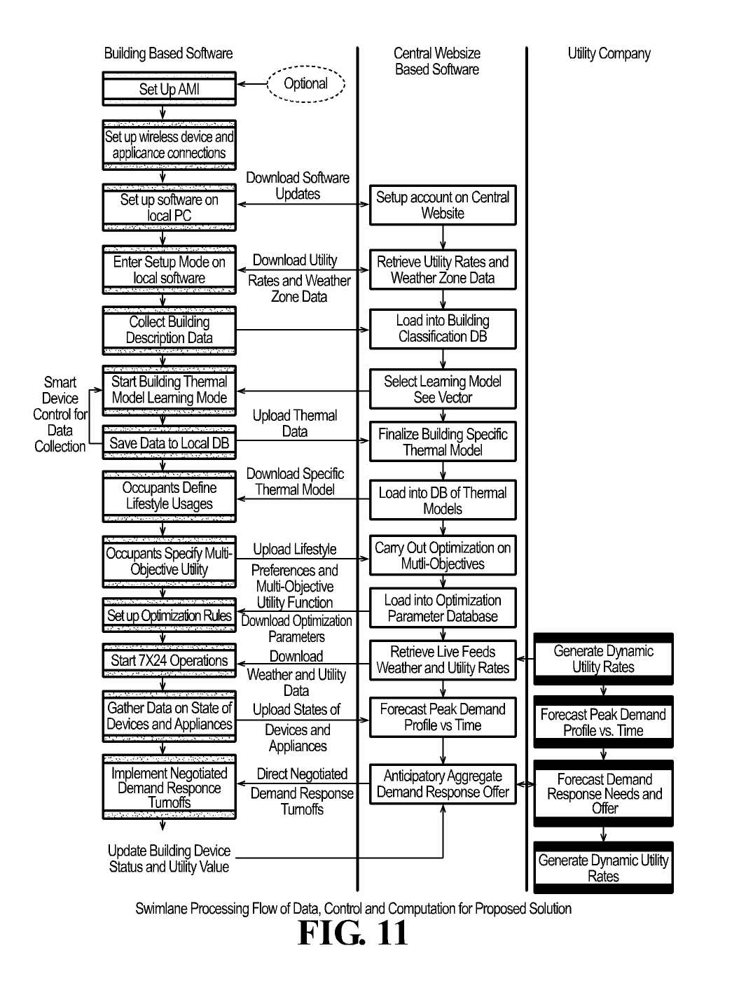

Another suite of implementation alternatives of the solution involve multi-buildings managed in concert. One instance involves instrumenting a large number of buildings in the same weather zone. This facilitates aggregating energy management “lessons learned” from all buildings for each building in monthly or yearly software updates. It also facilitates more accurate local weather forecasting than might be available from commercial weather data feeds. Finally, another implementation (shown in FIG. 10) would facilitate the demand response contractual relationship with the Utility Company for a large number of buildings. This allows the central web site to act as an Aggregator representing the larger energy consumption impact of all the buildings in its real-time negotiations with the Utility Company. This implementation facilitates more flexibility in negotiating with the Utility Company delivering greater cost reduction for each building owner/operator along with less sacrifice in comfort/convenience for each building occupant.

### 4.2 Overview of Major Elements

FIG. 6 illustrates the basic building blocks of a single building solution. Energy management software on the local processor communicates with the energy consuming appliances and devices via the wireless LAN to the remote control devices attached to them. Status of the appliances and devices (on/off, set temperatures, etc.) along with sensor data such as room temperature are sent to the local processor via the wireless LAN as well. The optimization software in the local processor uses the optimization rules developed for a specific building, reads the state of the devices and the buildings and determines new control directions to send to the appliances and devices (e.g., turn on, turn off, increase hot water set temperature, etc.). A number of alternative protocols are now available (with compatible device connections) to facilitate the control of such devices from the local PC software through a LAN (wireless or otherwise). These may include:
BACnet—building automation protocol including demand-response,
ZigBee—wireless consortium supporting wireless control of building devices,
OpenHAN—Home Area Network device communication and control,
OpenADR—price responsive and direct load control, and
OpenLynx—Open Source Initiative for integrated Building Automation Systems (BAS).

FIG. 7 shows another possible embodiment where the inventive subject matter may include the components shown in FIG. 6 along with an interface between the local processor and a central web site. In this embodiment a local PC is connected to the Web-based software via the Internet and relays the energy consuming status of the building the energy management system home Website. This architecture also allows the system to gather data on the energy consuming characteristic of the building under a variety of conditions and uses that data to determine a customized energy dynamics model of a specific building. This building-specific energy dynamics model may then be used to determine the optimum settings for all energy consuming devices in the building to minimize energy operating costs and carbon footprint. To accomplish the objectives of reducing energy cost and carbon footprint, the system employ software in a tangible media, such as hard drive, optical disk, RAM, storage cards, firmware, etc. The software may use one or more of live weather feeds, live energy cost structure feeds, the lifestyle preferences of the inhabitants of the building and the energy device state of the building to determine the optimum time-based control profiles for all the energy consuming devices. This software may employ an optimization algorithm tuned to optimize building energy consumption in the fastest convergence time to the best solution within the multi-objective value function.

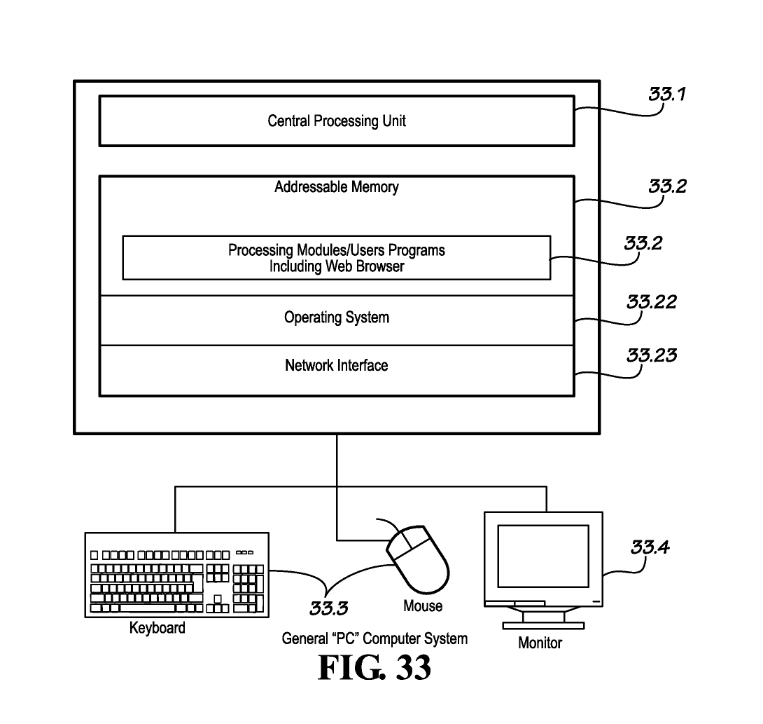

FIG. 33 illustrates features that would typically be found in a computer system that may be utilized in the inventive subject matter embodiments. As used herein, unless context indicates otherwise, “PC” generally means PCs as that term is generally known any general or special purpose computing device capable of executing the functions described herein, and may be a set of components that include one or more of the following: central processing unit (“CPU”) 33.1; memory 33.2 and processing modules 22 or user programs 33.21, operating system 33.22 and network interface 33.23, and related I/O subsystems 33.3 and 33.4, including one or more of the following: disk drive, keyboard, mouse, display monitor, networking card, other subsystems well-known in the art, and related software applications, including web browsers, web servers, database, and/or communications software. It will be understood by persons skilled in the art, that the PC may also be in the form of, but not limited to, tablet computing devices, portable and mobile devices, and gaming consoles, computing devices integrated into consumer electronics, such as TVs and set-top boxes, Personal Digital Assistant (PDA), wireless computer system or device capable of network communications over the Internet or other network, or computer terminal or Internet appliance capable of such network communications.

At least three functions distinguish this approach to building energy management include, but are not limited to the following:

1.) A module with a learning algorithm module used to develop a custom energy dynamics model for each specific building,

2.) A module with an optimization algorithm that leverages that custom energy dynamics model to determine the best set of rules for device energy management to minimize the energy operating costs while satisfying the needs and priorities of the building inhabitants, and

3.) A module that represents a large collection of buildings and manages their individual and collective participation in a demand-response program with the local Utility Company for further reduction in annual energy operating costs.

While a variety of specific embodiments are contemplated, a number of aspects comprising inventive subject matter may include one or more of the following:
Meta-heuristic optimization and sub-optimization techniques,
Optimization of dependent variables,
Comfort factors in the value function to be optimized,
Optimizing the building energy dynamics model for computational speed,
Predicting room-by-room temperature,
Wirelessly-controlled air vent registers,
Remote control of household appliances,
An initial building parameter database,
Additional sensors for the learning mode,
Sharing weather data with nearby buildings,
Participating with a large number of other buildings with an Aggregator-negotiator, and
Participating through an Aggregator-negotiator with a demand-response program of the local Utility Company.

### 4.2.1 Hardware/Software Components

### 4.2.1.1 Hardware

A number of hardware components may be utilized as building blocks for this solution. These hardware building blocks are all available from third party manufacturers today with the exception of remote controlled air flow vents which are aspects of the inventive subject disclosed herein.

### 4.2.1.1.1 Energy Consuming Device Control

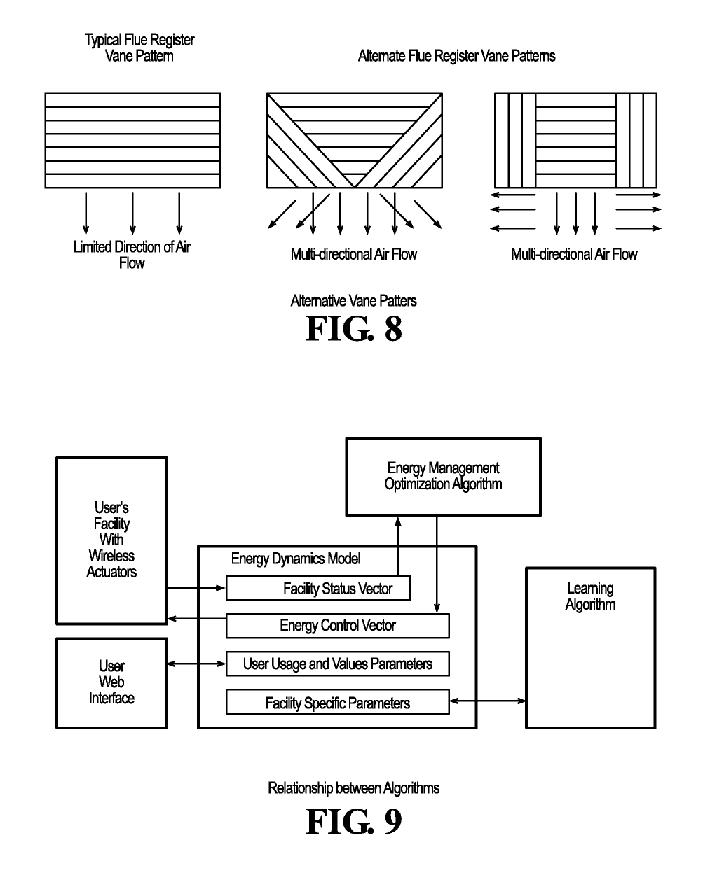

FIG. 8 shows some alternative vane designs for air flow registers. The vane pattern itself may be custom designed or drawn from the patterns shown. Today's flue register vane pattern only facilitates moving air in one of four possible directions often all at the same time minimizing efficiency of the temperature control process. Some embodiments may use a custom multi-direction vane design integrated with the gearing design for a more efficient management of air flow for temperature control.

Some embodiments may manage electricity-using resources. A wide variety of utilities and electronic devices consume considerable energy (even when turned off if they are left plugged in) when not being used which often is two thirds of the day (approximately ⅓ when at work and ⅓ when sleeping). This is because many devices don't have a true off mode when plugged in so as to facilitate a rapid warm-up and start for usage. Such devices include:
Home computers and printers,
Hot water heaters (may consume up to 25% of a home energy bill),
TV sets, DVD players, video game players, etc.,
Dishwasher,
Microwave, and
Washer/Dryer.

FIG. 6 shows an embodiment with remote wireless automated actuators for controlling a variety of devices shown. In some embodiments, wireless actuators may interrupt the current to the device thus taking it out of any energy consuming “sleep” mode. A remote computer system (e.g., the Corporate Website) may be programmed to re-connect the connection to current at a time shortly prior to normal usage (e.g., TV, computer, coffee maker, and microwave in the morning).

Controlling resources as noted above may be used to reduce total energy expenditure or time-shifting resource loads within the day. One example of reducing total expenditure could be shutting off the heat to a bedroom during the day. One example of time-shifting is blowing cold air into the house in the morning on a hot day, rather than running the air conditioner during the afternoon. Utilities may offer time-of-day or peak-load pricing. A forecasting algorithm may anticipate the increase in afternoon prices as well as anticipating the need for future cooling. Time-shifting of the energy consumption patterns for a single building may be multiplied over many buildings using the same energy management solution to aggregate to an overall effect of shifting (even leveling) the peak demand on the Utility Company.

### 4.2.1.1.2 Energy Consuming Device Communications

A number of protocols are now available (with compatible device connections) to facilitate the control of such devices from the local PC software through a LAN (wireless or otherwise). These include:
BACnet—building automation protocol including demand-response,
ZigBee—wireless consortium supporting wireless control of building devices,
OpenHAN—Home Area Network device communication and control,
OpenADR—price responsive and direct load control, and
OpenLynx—Open Source Initiative for integrated Building Automation Systems (BAS).

### 4.2.1.1.3 Sensors

Some embodiments may have direct sensors such as wind speed and direction, temperature, humidity, air quality, incident sunlight per unit area, or other measurements. Other embodiments may lack such direct sensors but use public weather station data. Still other embodiments may lack direct sensors and use public weather station data modified by a location, neighborhood, or microclimate-specific transform. For example, a few degrees may be subtracted from nearby weather station data on windy days for property located at the top of a hill. Further embodiments may use direct sensor data from nearby sources. For example, a house equipped with sophisticated sensors may make the data available to nearby neighbors. This information may be provided for free or at cost.

### 4.2.1.1.4 Building-Local Processor

One embodiment according to the inventive subject matter assumes the presence of, or will provide, a PC (e.g., desktop or laptop) of minimum processor speed, storage, I/O bandwidth and vintage of operating system. The energy management software may be loaded from a CD-ROM or DVD or jump-drive or downloaded from the internet.

### 4.2.1.1.5 Central Website Processors

The central website software may reside on dedicated data center class servers or on third party “servers as a service” or in the “cloud.” Some embodiments may use high-powered systems with substantial computing resources such as cloud computing, supercomputers, highly parallel machines, or distributed operating systems, and may be able to execute very sophisticated models. Some embodiments may be adapted to run on a desktop-class computer such as are frequently present in single family homes. Some embodiments may be adapted to run on low-powered systems such as low-power microprocessors such as ARM or Intel Atom, PIC-based microcontrollers such as OOPic, or AVR-based microcontrollers such as Arduino or ATMega16. Different levels of computing resources may require more or less sophisticated models.

### 4.2.1.2 Software

The associated computer processes according to the inventive subject matter may be made up of the following computer-implemented, executable steps, some or all of which may be used:
Software on local PC is installed and integrated to energy consuming devices and energy related instruments using one of the above interoperability protocols.
Software on local PC is used to set up an account on the Web-base software.
User specifies via a graphical user interface or GUI the layout of the building identifying the arrangements of the rooms and the location of energy-consuming devices and energy-related instruments.
User defines inputs via a GUI the building usage patterns of the inhabitants identifying when certain rooms are in use and certain energy consuming devices are in use by day of week (including holidays) and time of day.
User defines environmental comfort vs. cost value preferences along with energy cost savings goals (including demand response tradeoffs) for building via an interactive “adaptive question and answer” user interface.

### 4.2.1.2.1 Building-Local Software

FIG. 7 shows the relationship between the local processor and a remote computing system for managing and communicating with multiple different building or facilities of multiple users Website. Some embodiments may incorporate both a local processor and a remote server component. The remote server component may present a graphical or programmatic HTTP interface or API such as SOAP, REST, or XML. When the server presents an HTTP interface, the remote computing system is referred to herein as the “Corporate Website”.

In one embodiment, specific software would be downloaded into a local computer such as a home PC. The wireless thermostats and wireless control actuators would be installed and tested for communication validity. The local software would link up with the Corporate Central Website software and upload the customer specific data, possibly including, but not limited to, zip code, customer information and facility specifics such as size of facility, number of rooms, location of wireless thermostats, location of remote control actuators, etc. The user could then upload lifestyle data such as what rooms are used during what times of the day and days of the week along with target temperatures (minimums and maximums). The user would also upload their energy cost target and comfort-cost tradeoff value curve. This information gathering could be facilitated by a question and answer user interface that builds on early information provided by the user to eliminate some questions and prioritize others. This minimizes the investment time required for the owner/operator/occupant of the building to provide the information required for the models and energy management solution. This interactive information gathering process will be referred to herein as the “adaptive questioning” process.

### 4.2.1.2.2 Central Website Software

The Central Website software may be used to communicate and manage the local processor software in all the managed buildings. This software working in concert with the local software may include the following features:
The local software initiates the learning mode where by the various energy consuming devices are issued commands (e.g., off/on) and resulting data from the instruments are gathered. This data with appropriate time-stamps may be sent to the Central Website data base.
The home Website software analyzes the data through the learning algorithm which leverages a generic building energy dynamics model to estimate a best parameter fit to an energy dynamics model customized for that specific building.
The customized energy dynamics model for that building along with the cost structure from the local energy company and the usage patterns of the building is then exercised by the optimization algorithm to determine the optimal control rules to define control directions to be given to the energy consuming devices under specific external weather conditions (and short term forecast) to minimize energy costs while maintaining the user's desired comfort levels targeted by room and time of day.
These optimal control rules are downloaded into the local PC.
The home Website downloads the local 24 hour weather and utility rate forecast on a regular basis (e.g., daily) and updates on a more frequent basis (e.g., hourly). This download may also include a forecast of the time of peak demand load and the time at which the Utility Company will invoke their demand-response agreement and when they would move to higher rates.
The local PC software may use the control rules and data from the building's instruments to issue control directions to the energy consuming devices on a frequent basis (e.g., minute-by-minute) to manage energy consumption and reduce energy costs.
The Corporate Central Website may forecast and detect any changes in the rate structure (including that proscribed by the demand-response program terms) of the local energy company and update the optimization process accordingly.
The user may input any changes in the building layout or number/location of instruments of energy consuming devices.
The user may input any changes in usage pattern for the building or “comfort vs. cost” tradeoff curve.
Upon detecting any change from the user or the local energy company rate structure, the home Website may reactivate the optimization algorithm and download the resulting new energy control rules to the local PC software.
The user may define a tradeoff curve with Utility Company demand-response opt-in agreement based on different criteria including, but not limited to, time of day, day of week and holiday.

With the facility and user specific data uploaded, the local software and the Corporate Website software could synchronously launch the Training Mode. If the building was found to be a member of one of the building classification clusters, the seed parameters for that cluster could be downloaded to initialize the learning process. During training mode, the local software may exercise the installed remote control actuators through a number of cycles measuring the resulting room-specific temperatures along the way. This data stream may be fed into the Corporate Website based energy model. A learning algorithm could then optimize the fit of the model parameters to best represent the energy dynamics of the specific facility. This facility specific energy dynamic model could then be exercised through a wide variety of start states, external temperature profiles, room-specific target temperatures, and the customer comfort-cost tradeoff value curve in order to optimize the facility specific control parameters, control policies, and demand-response rules.

Some embodiments may be able to predict room-by-room temperature. This is advantageous because all rooms are not equally occupied nor are they equally instrumented (e.g., with thermostats). Some rooms are typically used at a particular time of day. For example, a bedroom is used at night but not during the day. While some approaches have heavily instrumented the premises with a temperature sensor in every room, this is unsuitable for some embodiments. For example, embodiments designed for low installation cost (e.g., single family homes) may only allow a few sensors. Accordingly, in this type of embodiment, room-by-room temperature would need to be predicted rather than directly measured.

Some embodiments may manage heating or cooling resources. One embodiment uses, for example, air register actuators to control air flow. This may be used for improving the efficiency of air heated or cooled homes, particularly large homes where usage patterns is concentrated on a subset of the available rooms depending on the season. This component may include a small wireless receiver, small electric motor, and a custom design of gears moving the air flow vanes.

### 4.2.1.2.3 Utility Company Software

It is anticipated that a Utility Company that participates in a Demand Response Program or leverages dynamic utility rates will implement software on their website to enable customers to communicate with them. This software will issue Demands for energy consumption reduction in a demand response program. This software will also broadcast utility rate changes. The Utility Company will publish interface specifications to enable third parties to interface with their software. Utility Companies will likely be required by State regulators to allow the reception of data streams from AMI meters.

### 4.2.2 Algorithms, Models and Methods

### 4.2.2.1 Building Energy Dynamics Models

Processing efficiency is crucial in many elements of the solution. Most energy dynamic models of buildings consist of differential equations (or their difference equivalents) that represent energy dynamics of walls, windows, air flow through connected rooms and associated vents and the consumption patterns of major appliances and devices. The development of such models and their facilitating software has seen a large growth in the last decade. Some of the popular commercially available energy dynamics models for buildings include:
BLAST—Building Loads Analysis and System Thermodynamics developed by US Army Construction Engineering Research Laboratory,
BSim—developed by the Danish Building Research Institute,
DOE-2.1E—developed by DOE and predicts hourly energy usage and costs for a building,
Ener-Win—developed by Texas A&M University,
Energy Express—uses a dynamic multi-zone heat transfer model, and
EnergyPlus Version 1.1.2—modular structured tool based on BLAST and DOE-2.

A number of models have also been developed by HVAC equipment manufacturers including Carrier and Trane.

### 4.2.2.2 Building Specific Energy Dynamics Learning Algorithm

Three possible elements to the implementation of the Learning Model and the development of a customized model of the energy dynamics of a specific building include, but are not limited to, the following:
A basic model of the energy dynamics of a generalized building,
A data stream with time based energy inputs and resulting comfort/convenience states from a the specific building in question, and
An algorithm to achieve a “best fit” for the parameter values of the model to the data.

There are at least two kinds of structures for the basic model of the energy dynamics of a generalized building or archetype of a subclass (e.g., two story, 4 bedroom two bath single family home) of building:
Customizing the parameter values of the differential equations (or difference equation equivalents) describing the heat transfer functions and appliance/device energy transfer functions of a specific building and
Customizing the n-space linear tile specifications of the components of a finite element model of the heat transfer functions and appliance/device energy transfer functions of a specific building.

Two possible approaches to determine the “best fit” parameter values for each modeling approach (differential equations or finite element model) are applicable:
Global search using the optimization techniques detailed herein for energy management optimization—namely Particle Swarm Optimization and Ant Colony Optimization to find the “best fit” parameter values to minimize the difference between the model predictions and the gathered data on the specific building and
Neural network learning algorithm applied to the model parameter values comparing model predictions vs. collected data on a time segment by time segment basis.

### 4.2.2.3 Building Category Classification Methods

It will be possible to search for categories of buildings with the development of specific building energy dynamics models over a large number and variety of buildings. The definition of categories of building energy dynamics will allow the association of a new building with a given category. That association may be used to seed the learning process and accelerate the convergence to a final building specific energy dynamics model. Two methods may be used in concert to define categories of building energy dynamics and assign a new building too a given category: cluster analysis and discriminant analysis respectively.

### 4.2.2.4 Single Building Energy Management Optimization

A building specific energy dynamics model may be used to determine the optimum energy management regime to optimize a specific value function reflecting the unique tradeoffs between lowering energy costs and comfort/convenience of the owner/occupants. Meta-heuristic methods may be applied to building specific energy dynamics models to search for the optimal energy management rules. Two specific methods uniquely suited to the demanding complexities of the energy management problem are presented herein: Particle Swarm Optimization (PSO) and Ant Colony Optimization (ACO). A unique advancement on the PSO method—the Irving-Wolfhound approach—is presented as a tailored solution directly applicable to optimizing building energy management within a demand response contract with the Utility Company.

### 4.2.2.5 Multi-Building Energy Management

One embodiment may include a multi-building advancement on the single building energy management optimization is presented by an extension of optimizing energy management aggregated over a large number of participating buildings. At least a minimum improvement in efficiency may result from sharing weather data across buildings in a similar weather pattern for improved forecasting of weather impact on optimal energy management for participating buildings.

### 4.2.2.6 Real Time Multi-Building Negotiations within a Demand Response Regime

An embodiment may include a multi-building extension wherein the aggregate of all participating buildings is optimized as a whole. This extension is particularly well suited for an Aggregator negotiating in real time with a Utility Company in a demand response situation. A unique solution leveraging the Irving-Wolfhound approach to forecast weather trends, energy consumption trends and to anticipate the height and timing of peak energy consumption for a local region is presented. This approach may forecast the timing of any utility rate change and manage energy consumption optimally under those anticipated conditions.

### 4.2.3 Data Bases and Data Feeds

A variety of data bases, files and data feeds may assist in the effective applications of the concepts and ideas presented. These may include the categories discussed in the following subsections.

### 4.2.3.1 Data Bases

### 4.2.3.1.1 Data Base of Building Definition Parameters

Some embodiments may assemble an initial building parameter database. These parameters may be assembled locally and downloaded during a service interval or may be reported to the Central Website. The aggregate database of parameters may have economic value if sold to provide additional revenue. The aggregate database of parameters may also be used to seed initial values for the learning algorithm. Seeding likely works better with some types of learning algorithms than others. However, with such a high dimensional space, seeding will improve all algorithms that operate on a search mechanism. The data base may also include swarm or ant agent behavioral properties including elitist or Queen behavior rules Data Base of Building Usage Parameters

Building usage parameters may be stored in a dedicated data base to facilitate pattern and trend analysis. This may also facilitate identification of correlation between usage patterns and optimal energy management rules.

### 4.2.3.1.2 Data Base of Building Energy Management Optimization Parameters

Each search method presented herein has a number of operating parameters integrated within the respective algorithms. A data base of these parameters may be stored. This may facilitate the analysis of correlation of effective operating parameters vs. building energy dynamic categories. For example, a Particle Swarm implementation could include, but not limited to, number of agents per neighborhood, number of neighborhoods per tribe, total number of tribes, starting location of each tribe, tribal birth and death rules, etc.

### 4.2.3.1.3 Data Base of Building Cluster Parameters

A separate data base may be maintained on the building description dimensions (e.g., how many stories, how many rooms, etc.). This data base may be used periodically (e.g., monthly in the beginning while the base of participating buildings is smaller than 1,000) to update the cluster analysis and discriminant analysis processes.

### 4.2.3.1.4 Data Base of Building Cluster Learning Seed Parameters

Learning seed parameters for each coherent cluster of building may be stored in a data base.

### 4.2.3.1.5 Data Base of Building Energy Management Optimization Seed Parameters

All meta-heuristic search methods may have starting positions in the value space. Certainly Particle Swarm Optimization and Ant Colony Optimization do. Effective (based on prior history) seed parameters for both the starting locations and agent behavior (e.g., weights in the PSO equation) may be stored in a data base organized by building cluster type.

### 4.2.3.1.6 Data Base of Utility Company Rate Schedules and Demand Response Rules

It is expected that the ultimate implementation of the submitted ideas and material may cover multiple States and multiple Utility Companies. A data base may be developed and maintained of all the rate schedules, escalation rules and demand response contract terms by Utility Company. Correspondingly, each building may have its corresponding Utility Company identified in Building Parameters data base.

### 4.2.3.1.7 Data Base of History of Utility Company's Demand Response Actions

A history of the actual demand response actions from each Utility Company may be captured and stored in a data base. The weather history and energy consumption profiles of participating buildings for a given day that lead up to a invoking of the Demand Response contract terms from the Utility Company may be stored in this data base. This data may be used to forecast Utility Company actions in real time.

### 4.2.3.1.8 Data Base of Demand Response Auction Bids

The demand response bids for the appliances/devices for the participating buildings may be stored and updated regularly (e.g., fifteen minute intervals) in a data base. This data base may be sorted by contribution to demand response by level of energy consumption reduced. The data base entries may be updated as the weather, usage zones and utility rates change.

### 4.2.3.2 Data Feeds

### 4.2.3.2.1 Weather Data Feed

The implementation of the ideas and energy management solution submitted may leverage an online national weather information feed. Such feeds are available from a number of sources. This weather information may be used to forecast short time (e.g., 4-8 hour time periods) weather trends in regional locations. These weather forecasts may be used refined the energy management rules and solutions along with forecasting Utility Company rate actions.

### 4.2.3.2.2 Utility Company Actions and Rate Feed

It is anticipated that the Company that owns the implementation of the building energy management solution submitted herein will negotiate and execute a contractual relationship with a given Utility. An information exchange link between the solution's central web site and the Utility Company will be set up. This information exchange link would facilitate the receipt of any demand response or similar rate change action by Utility by the Central Web Site. This information exchange link will also be used by the central web site to offer demand response actions to the Utility Company aimed at smoothing the peak demand curve. These demand response action offers may be developed in an auction fashion or in a simple offer, depending on the preferences of the particular Utility Company.

### 4.2.3.2.3 AMI Building Energy Consumption Data Feed

The contractual relationship between the owning Company of the Central Web Site and the Utility Company may include an agreement to provide AMI energy consumption data from each building to the Central Web Site. This may be necessary if the Utility Company is determined to be the owner of the AMI information. A number of movements are underway to legislate that the building owner is the owner of the AMI data. In this likelihood, the provision of the AMI data to the Central Web Site may be included in the energy management contract between the building owner and the owner of the energy management solution described herein.

### 4.3 Characteristics and Aspects of Algorithms and Methods

### 4.3.1 Value Functions

An embodiment of the problem being solved by the energy management solution may be validly represented by a Multi-Objective Optimization Problem (MOOP). A multi-objective optimization problem has a number of objective functions which are to be minimized or maximized. A practical consideration involves any constraints that may be placed on the solution variables; this then defines the allowable solution space. For example, the constraints on the hot water heater set temperature could be 60 and 120 degrees Fahrenheit.

Three of the objectives and corresponding value functions for the energy management solution described herein:

maximize V_{CC}=V(comfort, convenience and productivity of owners and occupants)

minimize V_{B$}=V(annual building energy management costs)

maximize V_{DRC}=V(compliance with demand response contract with Utility Company)

For an embodiment, a Value Function may be developed for three implementation instances which will be the space in which the meta-heuristic methods will search for the optimal solution. The three instances discussed herein are Single Building Value Function, Multi-Building Value Function and Demand Response Value Function. The Demand Response Value Function incorporates the Multi-Building Value Function. The Multi-Building Value Function incorporates the Single Value Building Function for each building covered.

The nomenclature used for the some of the various value functions is as follows:
Sum of the comfort-convenience dimensions i=1, n
Sum of the energy cost factors by appliance/device j=1,m
Sum of all the time periods (typically by hour in a 24 hour day) k=1,24
Sum of all the participating buildings l=1,p

### 4.3.1.1 Single Building Value Function

The multi-objective value function for a single building combines the comfort/convenience value functions and the annual energy cost value function for that building. The following equation is shown in a linear form although an implementation instance may find advantages in the nonlinear form.

V_{sb}=Σ_{i=1,n}(w_{(CC)}_{ᵢ}×V_{(CC)}_{ᵢ})+Σ_{j=1,m}(w_{(BS)}_{ⱼ}×V_{(B$)}_{ⱼ})

### Where:

w_{cc} is the weight given to the comfort/convenience value for function for that building,
V_{cc} is the comfort/convenience value score for that building,
w_{B$} is the weight given to the monthly energy costs for that building, and
V_{B$} is the value score representing the monthly energy costs for that building.
   Elements of the comfort and convenience value function objective may include:
   Lifestyle usage factors:
      What rooms are heavily used during what time periods.
      Preferred times for appliance usage such as washer and dryer.
      What time periods the house is complete empty of occupants.
   Comfort/Convenience Sensitivity factors:
      Target temperature for each room under each usage zone.
      Allowable temperature deviation from target by room and usage pattern (e.g., must be plus or minus two degrees from target temperature in family room during prime evening television hours).
      Allowable time deviation from target from when hot water heater is returned to peak temperature (e.g., plus or minus fifteen minutes).

These considerations may often be captured in a linear or nonlinear preference function. A linear preference function is a weighted linear sum of component level value functions. Such a linear preference is:

V_{CC}=Σ_{i=1,n}wᵢ×Vᵢ(Target−Actual)

where:
Vᵢ is the value function for a single comfort/convenience dimension (such as the temperature of the family room during prime time TV viewing in the evenings) and
wᵢ is the numerical weight reflecting the importance of that dimension to the occupant.

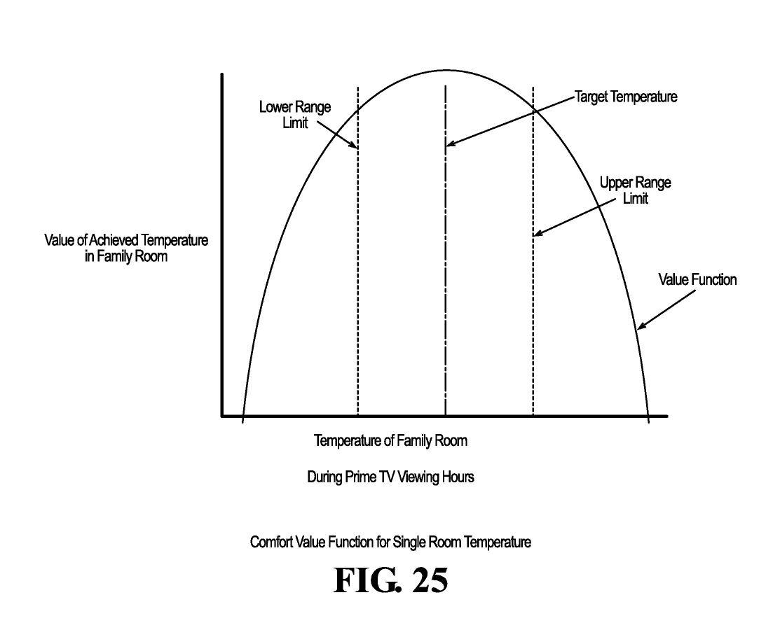

FIG. 25 illustrates such a comfort component value function. The FIG. shows how the value peaks when actual temperature is exactly on the target temperature. The value function diminishes slightly as the actual temperature deviates from the target temperature but stays within the upper and lower sensitivity bounds. However, the value function diminishes rapidly as soon as the actual temperature begins to deviate from the target outside of the upper and lower sensitivity bounds. If the actual temperature deviates far enough from the target, the value function provides zero points into the sum. Negative values are also possible in such value functions.

Two steps in developing linear value functions that represent the preferences of the occupants may include:
Scaling the dimensions of each component such that their natural ranges don't create distortions, and
Determine the weights to accurately reflect the value preferences of the occupants.

Conversely, the most common nonlinear function is a mathematical product (multiplication) of the component level value functions, this does away with the complexity of determining the weights required by the linear value function. Such a value function may be represented by:

V_{CC}=Σ_{i=1,n}Vᵢ(Target−Actual)

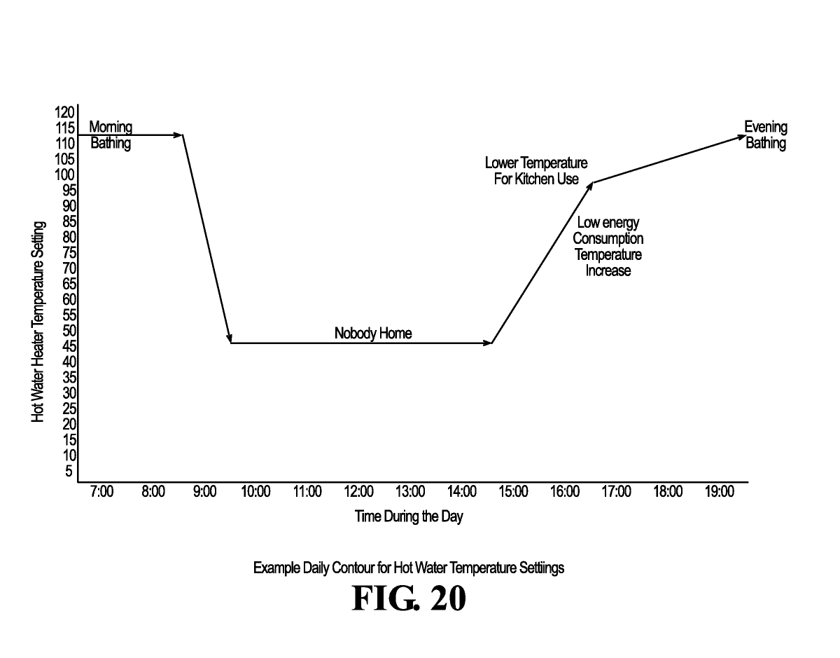

Comfort is well understood to be based on a variety of factors including temperature, humidity, and indoor air quality. This method may account for lifestyle usage needs and recognize opportunities to lower energy consumption cost with little to no sacrifice in comfort/convenience. An example is turning the target temperature on the hot water down (or completely off) while nobody is home and then turning it back up in time to return to the normal hot water temperature before any occupants arrive home. In a demand-response scenario, the hot water heater (see FIG. 20) and stove might be turned off instead of the air conditioning on a hot summer Saturday when the occupants are home for minimal sacrifice in comfort/convenience The multi-objective function for a single building (an embodiment of an implementation of this approach) may be developed by the determination of a preference function reflecting the occupants' tradeoffs between cost reduction, comfort and convenience and carbon footprint reduction. This occupant value function may be determined through direct elicitation or indirect methods. An example of a direct method could be implemented by a GUI posing choices in the multi-objective space in a questionnaire format. This approach may elicit the preference function from the occupant representative. An example of such occupant value questions is—“pick the desired alternative”:
a. Reduce annual energy costs by $1,000 and control a targeted room temperature to within +or −5 degrees of the target temperature, or
b. Reduce annual energy costs by $300 and control a targeted room temperatures to within +or 2 degrees of the target temperature

The software may use answers to each prior choice question to formulate the next pair of choices in a fashion to determine the preference function calibration in a minimum number of questions. This method also collects the data necessary to determine if the occupants' preference function may be validly represented by a linear weighted sum function or might (in an alternative implementation) need to deploy a nonlinear preference function. A best fit method applied to the occupant/owner's answers will be used to determine both the shape of the component level value function (example in FIG. 25) and the weights in a linear preference function.

The value function being optimized may be aggregated over the course of a complete day:

V_{optimized}=Σ_{k=1,24}(Σ_{i=1,n}w_{(CC)}_{ᵢ}×V_{(CC)}_{_{i,k}}+Σ_{j=1,m}w_{(B$)}_{ⱼ}×V_{(B$)}_{j,k})

Once the single building comfort/convenience preference is developed, the software may forecast overall annual energy cost savings. The software may show the owner/occupant for which components the user's value function is preventing further annual energy cost savings. At this point the software may allow the user to “edit” their value preferences to achieve better energy cost savings. This cost savings estimate may be updated again once the building-specific energy dynamics model has been built and the optimal energy management profile determined.

The local software may use the building usage zone definitions, local weather data, the building specific energy model and the usage zone based value functions to simulate the use of the building including its appliances/devices for a year. This annual usage simulation would then leverage the historical utility bill data and the utility rates to forecast the annual utility bill along with corresponding energy cost reductions. The user may be provided with a screen report or printout identifying largest sources of energy bill reduction and largest remaining opportunities. The user may then be offered at least two modes from the local software: 1.) annual energy cost target driven solution and 2.) value function refinement via further selected cost-comfort tradeoff questions.

The annual energy cost target approach may ask the user for their cost goal and then uses a parameter relaxation method on the usage zone value functions to seek ways to achieving the cost target. An example of the parameter relaxation method is evening hour living room temperature upper and lower limits. If the user originally set the limits as plus or minus 3 degrees from the preferred temperature of 70, then the parameter relaxation method may explore the additional cost reduction that would result from expanding this limit to plus or minus 5 degrees from preferred temperature. Once the parameter relaxation method completes its processing, the user may be presented with a report identifying the parameters that were relaxed (and by how much) in order to accomplish the annual cost target. At this point the user may accept the recommendations in total, revise the cost target value and re-run the parameter relaxation processing or elect the value function refinement mode.

The local software may pose additional comfort vs. cost tradeoff questions to the user in the value function refinement mode. These additional questions may be designed to offer cost reduction opportunities that the original value function did not leverage. Once the additional questions are answered by the user and the value function update, the annual energy cost may be forecasted again. The user may continue using either the parameter relaxation method or the value function refinement mode until they are satisfied with the forecasted cost and comfort-convenience operation rules.

A third objective—compliance with the demand response contract with the Utility Company—is implemented via a “bid aggressiveness” factor. This may reflect the level of interest the building's owner/occupants have in qualifying for the utility rate reduction offered by the Utility Company for demand response compliance. In a single building implementation, this may reflect the additional comfort/convenience sacrifice the owner/occupant is willing to make to qualify for the demand response utility rate reduction. In the multi-building implementation, the “aggressiveness factor” may be used to implement an auction bidding process with the other participating buildings. Those buildings with a higher aggressiveness factor offer to sacrifice greater comfort/convenience to accomplish a given energy consumption reduction. These buildings in turn are awarded (as a result of the auction bidding process) a larger share in the rate reduction award from the Utility Company.

The demand response aggressiveness factor may be estimated via a series of choice questions that were used to determine the baseline value preference function. These questions merely address the additional comfort/convenience the user is willing sacrifice in order to qualify for larger and larger shares of the demand response utility rate reduction.

### 4.3.1.2 Multi-Building Value Function

An embodiment of the multi-building value function (not operating in a demand response scenario) may be the sum of the value functions of all the individual buildings. This linear sum may be weighted by the total monthly energy consumed by each respective building. Thus, the weights will be forecasted monthly and the multi-building value function updated accordingly. This may facilitate advising the participating building on how to save energy costs as an aggregate whole, a first step to being ready to negotiate a demand-response contract with a utility company.

Vₘᵤₗₜᵢ=Σ_{l=1,p}(Σ_{j=1,m}(w_{(B$)}_{ⱼ}×V_{(B$)}ⱼ))ₗ

where:
w_{B$j} is the weight given the jth appliance/device and
V_{B$j} is the monthly energy costs for the jth appliance/device.

### 4.3.1.3 Demand Response Negotiations Value Function

The Demand Response negotiations value function may include all three of the overall objectives including the single building value function. The Demand Response Aggregation optimization has another complication in that it includes a dynamic target the forecast of which must be included in the optimization problem. This is the forecast of “if and when” the aggregate peak energy consumption demand will reach the stage that the Utility Company will invoke its negotiated Demand Response authorities and begin turning off appliances and devices in targeted buildings. The demand response value function will put the highest priority on compliance with the terms of the demand response contract with the Utility Company. This will push some individual buildings down towards the limits of their comfort/convenience bounds. Since the optimization will be designed to accomplish the objectives over the time period of a 24 hour day, the value function may be designed to encourage time-shifting of energy consumption to accomplish smoothing of the peak consumption demand curve. The demand response value function may be expressed as:

V_{DRL}=Σ₍ₖ₌1,m j=1,n)V_{(DRC)}_{_{j,k}}

### Where:

k is the counter for each hour of the twenty four time period being optimized, or

V_{(DRC)}_{ⱼ}=Σ_{k=1,24}V_{DRC}(Demand Response Compliance Target $−Actual $)

### 4.3.2 Optimization

The optimization algorithms that may be applied to address the Utility Company Demand Response real time negotiations may be designed to be successful with dynamic stochastic optimization of multi-objective value functions in highly dimensional hybrid search spaces. Such algorithms with novel applications in the inventive subject matter include, but not limited to, Particle Swarm Optimization (PSO) and Ant Colony Optimization (ACO) and refinements of each of these to tailor the approaches to the specifics of this type of problem. PSO is often used when the search space is discrete, hybrid, non-continuous or non-differentiable as is the case in both energy optimizations of a single building and aggregate Demand Response negotiations for a large number of participating buildings. PSO has also shown to be very efficient at optimizing over dynamic search spaces such as was shown in the “moving peaks” test problem. In this case a multi-swarm variant is very effective.

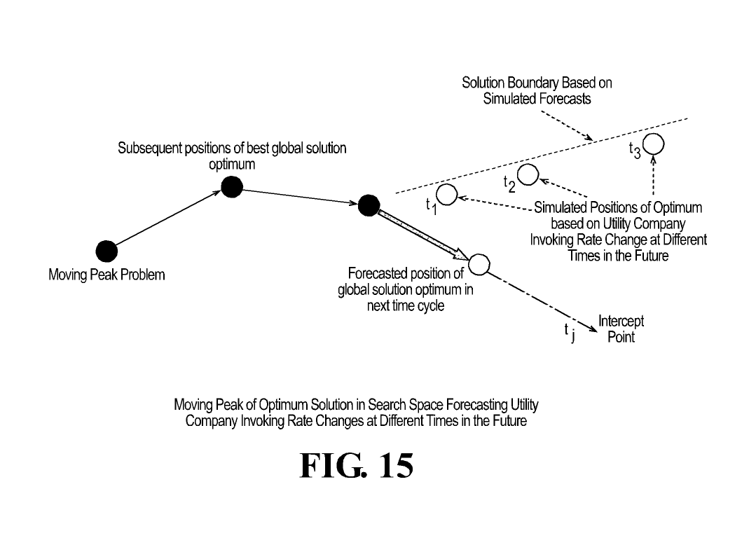

The moving peaks characteristic in the energy management application is a result of the change in weather over the course of a day in a somewhat predictable fashion (within a given local geography). FIG. 15 illustrates a typical movement (shown by the black dots) of an agent in search space (simplified to a two dimensional search space for illustrative purposes). FIG. 15 also shows a forecasted position of the optimum (shown by the gray dots connected by the solid gray arrows) based on simulation models of the weather for the locality and the location of the optimum in search space based on those forecasted weather conditions. The location of the forecasted optimum based on the weather forecast may be considered in the PSO calculations as if they came from a Queen (super performing) agent. FIG. 15 also shows an effect of forecasting a disruptive change (shown by the gray dots on the dotted gray line) such as might occur should the Utility Company invoke a Demand Response and change its rate structure accordingly. As shown in FIG. 15, this change in utility rate structure could represent a dislocation in the movement trend of the optimum solution (as opposed to the smooth trend resulting from gradual changes in the weather). The method proposed herein is uniquely tailored to address the optimization complications resulting from weather trends and utility rate structure changes (i.e., changes both gradual and abrupt).

### 4.3.2.1 Particle Swarm Optimization (PSO)

### 4.3.2.1.1 Introduction

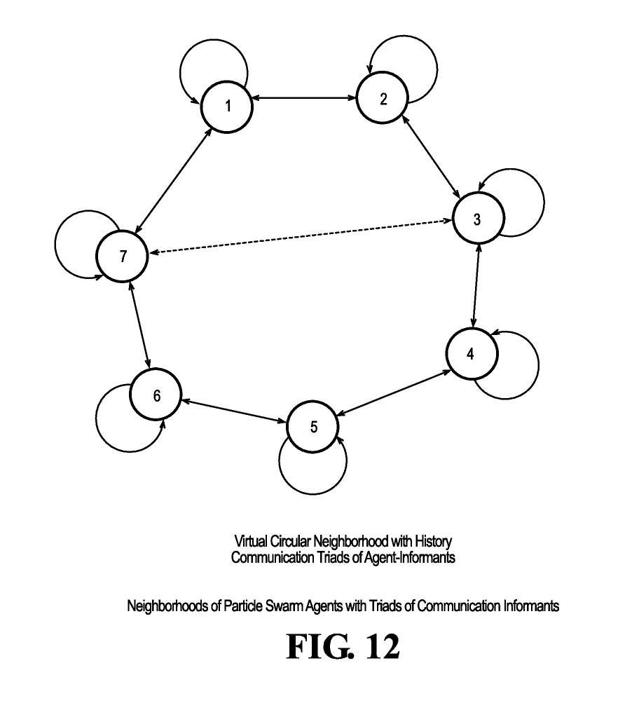

PSO consists of a set of collaborating agents (algorithm-based and software-implemented); each agent has a location and velocity in the search space. Each agent uses the value equation for a given building or a set of buildings to calculate the value (in terms of cost-comfort tradeoffs) of its location in the search space. It then compares with its previous locations and their associated values. It then determines the location of its best value within a given processing session and carries this in memory along to the location of the next calculation. Agents are organized into communicating neighborhoods as shown in FIG. 12. The agents shown in FIG. 12 are organized into trios of agents that communicate or share the location of their best solution to date. The seven agents in FIG. 12 are also organized into a tribe that collaborates in that each agent shares its best value location with its nearest neighbor. Variants of tribes may take almost any structure with agents' communication with other agents that are not their nearest neighbor shown by the dotted gray arrow in FIG. 12.

The updated motion of each agent in the search space is managed by the equation:

Vᵢ^{t+1}=Vᵢ^{t}+φ₁U₁^{t}(pbᵢ^{t}−xᵢ^{t})+φ₂U₂^{t}(gb^{t}−xᵢ^{t})

### Where:

Vᵢ^{t+1}=the velocity of the agent in the search space at the t+1 processing interval,
Vᵢ^{t}=the velocity of the agent in the search space at the t processing interval,
φ₁ and φ₂ are random weighting numbers drawn from distributions tailored for the search space,
U₁^{t}(pbᵢ^{t}−xᵢ^{t}) is a component of the velocity change reflecting the difference between the value of the present location x and the personal best (or pb) that this agent has found, and
U₂^{t}(gb^{t}−xᵢ^{t}) is a component of the velocity change reflecting the difference between the value of the present location x and the group best (or gb) that the agent's neighborhood has found.

Similarly, the updated position change of an agent in the search space is represented by:

x^{t+1}=x^{t}+v^{t+1}

### Where:

x^{t+1}=the location of the agent in the search space at the processing cycle t+1,
x^{t}=the location of the agent in the search space at the processing cycle t, and
v^{t+1}=the influence of the velocity during the processing cycle t+1 on the location of the agent in the search space.

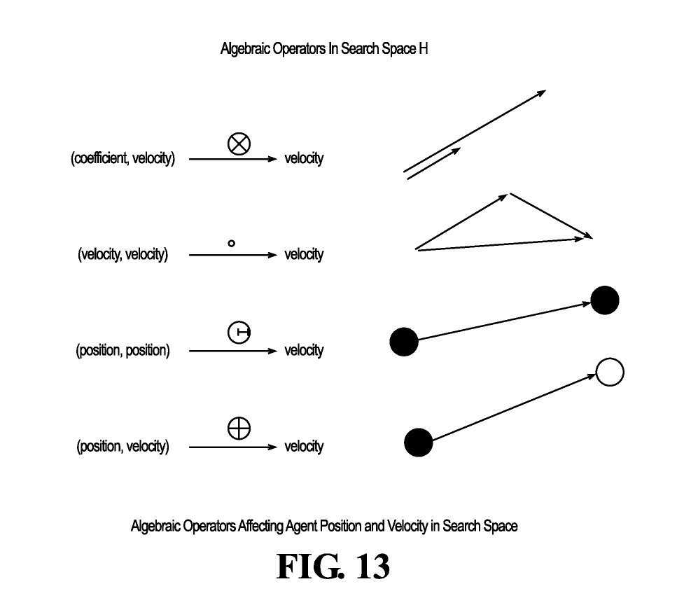

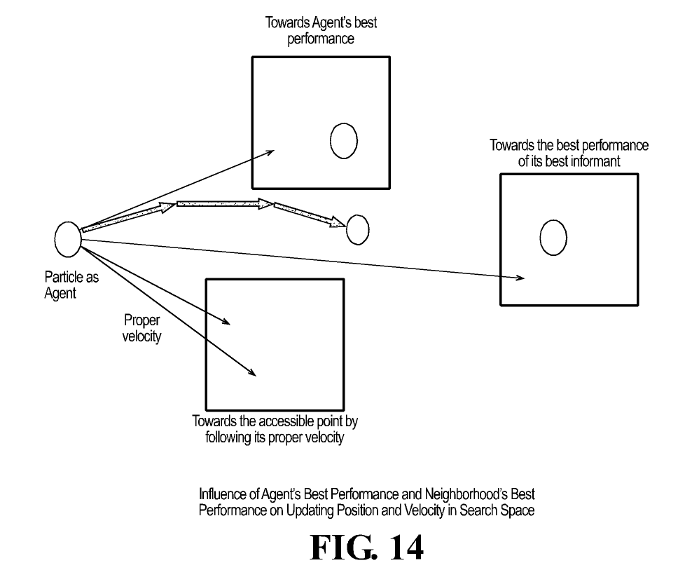

Thus an implementation of a PSO method utilizes a number of algebraic operations in the search space as shown in FIG. 13. The net result of these influences on the position and velocity of an agent in search space is depicted in FIG. 14. All the agents move through the search space as influenced by what they find, remember and are “told” by the members of their neighborhood and tribe in their quest for the best energy management solution.

Variants of multi-agent search such as Tabu search appear less effective for this energy management problem space because of the discontinuities in the value defined search space. Tabu search which prevents an agent from going back to a region near a low valued solution may be preventing an agent from crossing over a nearby discontinuity edge to a much higher valued solution.

### 4.3.2.1.2 Irving-Wolfhound Advancement

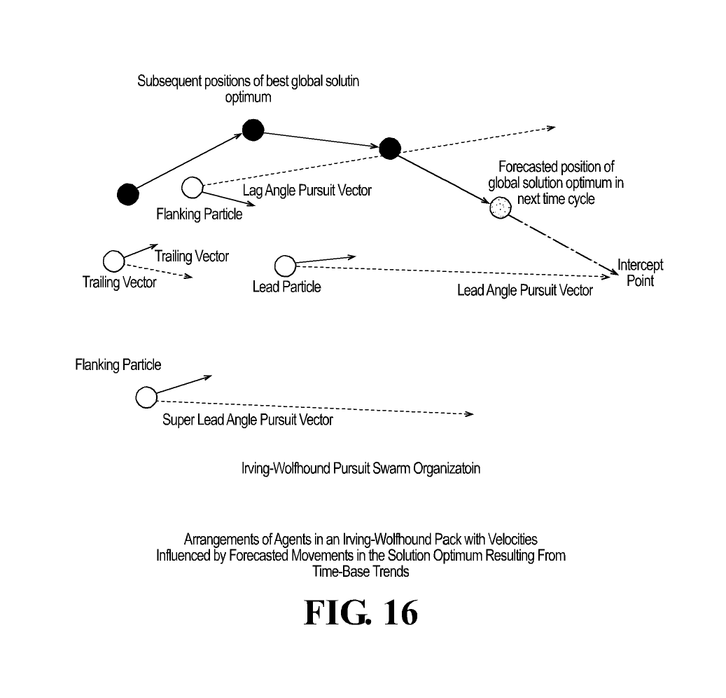

A novel extension of PSO tailored to address this type of dynamic, time-varying optimization problem is the Irving-wolfhound approach. This PSO-based approach features a structured hunting swarm similar to the organization used by a pack of wolfhounds as they would hunt and chase wolves, deer, rabbit or other prey. In this case, the velocity/direction vector of the prey is estimated and the swarm spreads out with a leader (elitist or Queen in PSO language) and other members of the swarm (pack) take flank positions in anticipation of likely turns the prey might make. This arrangement of collaborating agents is shown in FIG. 16. The prey in this case is the global optimum in the search space. FIG. 16 depicts this by the trail of black dots representing the best solution positions in the search space found by the PSO. The position of best solution is forecasted based on simulation models of the weather and the historical data of the optimum found under those weather conditions (shown by the gray dots and solid gray arrow in FIG. 16). The further movement of the best solution is shown by the gray dotted arrow in FIG. 16. The FIG. depicts the intersection of the lead particle or agent's optimum velocity vector with this forecasted position of the best solution or intercept point.

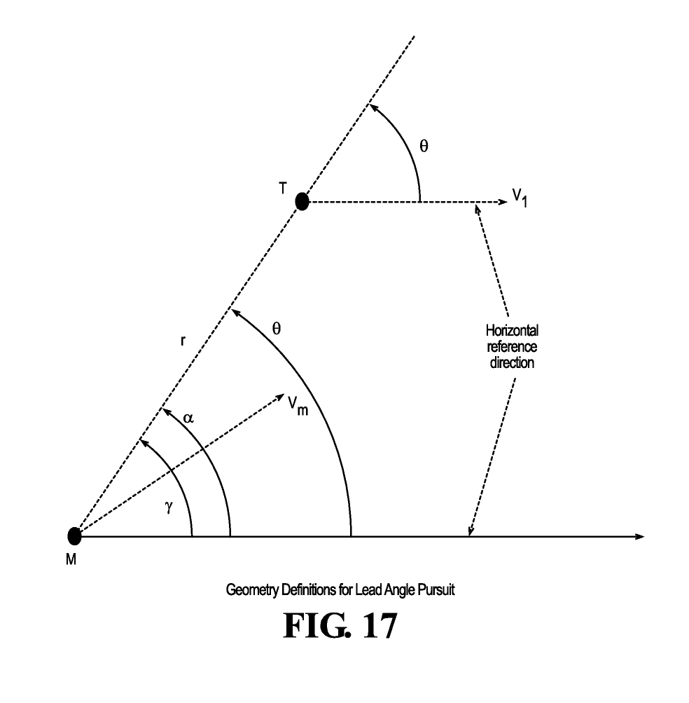

The Irving-wolfhound method integrates pursuit (sometimes called predator-prey) algorithms (typically used for air-to-air combat modeling) with the PSO equations. A leader is designated by the shortest time to intercept the forecasted path of the target (in this case the multi-objective optimum). This shortest time is calculated by the lead-angle equations. The lead angle geometry (again shown in two dimensions for simplicity) is shown in FIG. 17, The lead angle is calculated using an estimate of the velocity vector of the best solution (or prey) that delivers an intercept point in the shortest period of time given the velocity limits of the agents. FIG. 17 depicts a target T moving at a constant velocity V_{t.} (shown by the dashed arrow). The orientation of the target defines the reference direction. A master-agent M (shown by the solid black arrow) moving along the velocity vector Vₘ wants to intercept the target. The other elements of FIG. 17 are:
θ=the line of sight (LOS) angle, and
γ=the lead angle or the angle of the lead wolfhound agent with respect to the reference direction.

The lead wolfhound agent will vary γ such that θ remains constant thus ensuring an intercept.

The equations for determining γ involve solving the following differential equations of motion:

$$\frac{d r}{d t } = {V}_{t} cos ( θ ) - {V}_{m} cos ( {φ}_{o} - k θ ) = {V}_{r} ( θ )$$

$$r ( d \frac{θ}{d t} ) = {V}_{m} sin ( {φ}_{o} - k θ ) - {V}_{t} sin ( θ ) = {V}_{θ} ( θ )$$

### Where:

r=radial distance from the lead wolfhound agent to the target, and
k=N−1 where N is a navigational constant between 3 and 5.

Once a lead agent is determined (as illustrated in FIG. 16, for example,) neighboring members of the pack then assume flanking or trailing roles by adjusting their velocity vectors to achieve lag-angle pursuit orientations (and corresponding estimated target-intercept positions) or super-lead angle pursuit orientations on the other side of the leader. This achieves a spread of the swarm that will cover likely changes in direction on the part of the prey (best solution). The two flanking swarm members maintain a target angle orientation with the leader at a distance from the leader determined by the velocity vector estimate of the multi-objective function peak. FIG. 16 illustrates the relationship of the leader, flanking swarm members and the forecasted velocity and position of the target optimum. Similarly, trailing members of the swarm will adjust their velocity to allow for a doubling back maneuver on the part of the target. This approach will work well in handling the optimization of the negotiation with the Utility Company for Demand Response including forecasting the time and extent of peak demand.

The novel Irving-Wolfhound solution is tailored for the novel aspects of the Demand-Response energy management optimization problem by combining the basic PSO equations with the lead angle pursuit equations:

Vᵢ^{t+1}=Vᵢ^{t}+φ₁U₁^{t}(pbᵢ^{t}−xᵢ^{t})+φ₂U₂^{t}(gb^{t}−xᵢ^{t})+φ₃U₃^{t}(lab^{t}−xᵢ^{t})

### Where:

φ₃=a weight emphasizing the confidence in anticipating the movement of the best solution as forecasted by weather trends and the likelihood of a change in the utility rate structure, and
lab^{t}=the best solution determined by the lead angle pursuit equations.

There are a number of ways to implement the Irving-Wolfhound solution. At a minimum, the relative weights φ₁, φ₂ and φ₃ may be varied to represent the likelihood that a utility rate change is imminent. Tribes may be formed with special purposes. A number of tribes may ignore the weather trend and utility rate change likelihood (φ₃=0). Other tribes may focus on pursuing weather impacted forecasts only. Additional tribes may pursue the potential event that the Demand-Response utility rates will be invoked at specified intervals in the future, for example—1 hour from now, 2 hours from now and 3 hours from now.

### 4.3.2.2 Ant Colony Optimization (ACO)

The Ant Colony Optimization (ACO) approaches have shown effectiveness at model-based optimization as opposed to instance-based optimization. Most of the classic search methods may be considered “instance-based” since they generate new candidate solutions using solely the current solution or the current population of solutions. In model-based search algorithms, candidate solutions are generated using a parameterized probabilistic model that is updated using the previously seen solutions in such a way that the search will concentrate on the region containing high-quality solutions. Typically the model in model-based search is not a functional replica of the real world problem being solved. A variant named “reinforcement learning” does use such real world oriented models. Building energy management lends itself to this reinforcement learning approach with the plethora of mature, proven models of building energy dynamics available for use.

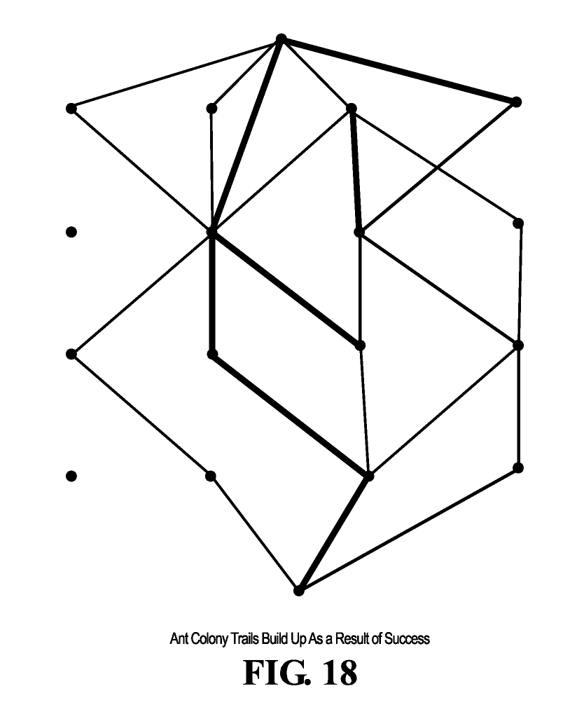

ACO methods use algorithm-defined and software implemented agents modeled on ant-like behavior who “communicate” by the strength of pheromone they leave behind in their trail. The greater the value of the “food” (in this case the value of the energy management solution) the ant-agent finds, the stronger the scent of the pheromone left on the trail. As more and more agents find the more valuable regions of the search space, they leave “attractive” trails for other ants to follow. Any new ant-agent then, when faced with a trail segment choice, will follow that segment with the strongest pheromone (implemented mathematically by value placed on the trail segment). This phenomenon is depicted in FIG. 18 by width of the lines connecting the dots in search space. The heavier lines in FIG. 18 depict those trail segments high in pheromone or value.

This ant-agent behavior is implemented by the following set of equations.

Edge selection by an agent-ant is determined by:

$${ρ}_{ij} = \frac{( {τ}_{ij}^{α} ) ( {η}_{ij}^{β} )}{\sum ( {τ}_{ij}^{α} ) ( {η}_{ij}^{β} )}$$

### Where:

τᵢⱼ is the amount of pheromone on trail segment ij,
α is the parameter to control the influence of τᵢⱼ,
ηᵢⱼ is the desirability of trail segment ij, and
β is a parameter to control the influence of ηᵢⱼ.

Pheromone Update is determined by:

τᵢⱼ^{α}=(1−ρ)τᵢⱼ+Δτᵢⱼ

### Where:

τᵢⱼ is the amount of pheromone on trail segment ij,
ρ is the rate of pheromone evaporation, and
Δτᵢⱼ is the amount of pheromone deposited, typically given by

$$Δ {τ}_{ij} = \frac{1}{{L}_{k}}$$

if ant-agent k travels on trail segment ij, or equals 0 otherwise.

In general, ACO methods have been shown to be very effective and competitive for the more complex optimization problems that include:
1. dynamic problems in which the instance data such as objective function values, decision parameters or constraints may change while solving the problem;
2. stochastic problems in which one has only probabilistic information about objective function values, decision variable values or constraint boundaries due to uncertainty, noise, approximation, etc.
3. Multiple objective problems in which a multiple objective function evaluates competing criteria of solution quality.

### 4.3.2.3 Building Classification

Each building may be described with respect to physical layout, location and type of energy consuming devices/appliances, location and type of sensors (e.g., thermostats) and control mechanisms (e.g., remote control register vents). A GUI may be provided either over the Internet or loaded on a local PC to facilitate the owner/operator/occupant's providing this building-specific information. These parameter values are organized into Meta variables that in turn will be used to classify a building by energy-consuming type. An example of a Meta building classification dimension is “openness”—the extent to which adjacent rooms are open to each other facilitating air flow and a resulting temperature sharing environment.

Oₚ=A(i,i+1)+A(i+1,i+2)⁻²+ . . . +A(i+n,i+n+1)⁻⁽ⁿ⁺¹⁾

### Where:

Op=the openness of air flow from neighboring rooms into room i, and

A(i,i+1)=the square footage of the area of the opening (e.g., door, archway, low wall, etc.) between the iₜₕ room and its nearest neighbor, the i+1st room.

Another example is a close-distant metric which measures the distance of various air control vents along a heating-cooling duct representing the density of air flow within a series of rooms.

$$CD = \frac{number of air flow vents over n rooms}{\begin{matrix}Distance along the air flow duct \\ from the first room to the furthest room\end{matrix}}$$

Numerous such Meta dimensions may be defined where they measure a building's ability to have hits energy easily controlled. Each building then may be defined by a combination of simple (e.g., two zone temperature controls) and Meta (as discussed prior) dimensions.

The use of such building description and definition dimensions facilitates the classification of new buildings with subsets of the central data base by similarity of their control of their dynamics. This building defining/describing data base may then facilitate the novel application of classification methods such as multi-dimensional scaling, discriminant analysis and pattern classification.

### 4.3.2.3.1 Cluster Analysis

The major consumption of processing/storage resources in the implementation of this submitted energy management approach may occur during:
1.) the learning phase of creating the building-specific energy model, and
2.) solving the optimal solution for large numbers of buildings in real time during the real-time demand response negotiations with the Utility Company.

The actual control of the energy consumption of a specific building is less demanding in that most of the control decisions have a large lead time measured in hours (e.g., when to turn down the hot water heater and when to turn it back up—FIG. 20).

Processing demands may be lowered in the learning phase by using the building classification process (using discriminant or pattern classification techniques) to seed the learning process with highly relevant energy dynamics model parameter values and thereby accelerate the convergence to the match parameter set. Processing demands may further be reduced in the learning phase once enough data has been gathered to define robust building energy dynamics classification clusters.

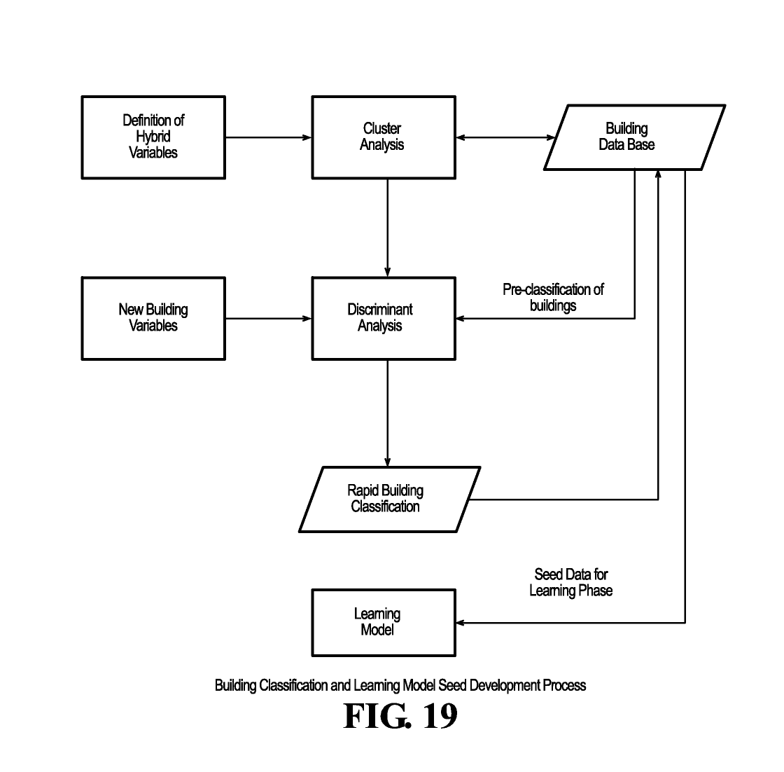

FIG. 19 depicts the flow of data and analysis in support of a robust building energy dynamics classification process. Two algorithms are used in tandem: cluster analysis and discriminant analysis. Cluster analysis does not require pre-classification of buildings and will be used first to determine which variables are relevant and how many groupings are necessary to effectively discern among the different energy dynamic types of buildings. The results of the cluster analysis may then be used to reduce the number of categories and dimensions used in the discriminant analysis. Ultimately, effective categorization of buildings by energy dynamics type may facilitate the selection of seed parameter values to accelerate the convergence of the learning process to determine the building-specific energy dynamics model for each building.

A common measure of similarity for identifying related groups in cluster analysis is the correlation coefficient:

$${r}_{jk} = \frac{\sum ( {x}_{kj} - {\overline{x}}_{j} ) ( {x}_{jk} - {\overline{x}}_{k} )}{\sqrt{\sum {( {x}_{y} - {\overline{x}}_{j} )}^{2} {( {x}_{jk} - {\overline{x}}_{k} )}^{2}}}$$

Where xᵢⱼ is the value of the iₜₕ variable for case j and xⱼ is the mean of all values of the variable for the case j. The correlation coefficients may be used to identify the number of coherent groups and which buildings belong to a common group. The correlation coefficients may also be used to discern the highly relevant dimensions from those of low relevance. The highly relevant dimensions may be used then in the discriminant analysis for improved efficiency of selection of learning phase seed parameters and rapid convergence to the building-specific energy dynamics model.

### 4.3.2.3.2 Discriminant Analysis

Discriminant Analysis depends on the pre-classification of groups. In this case this may be done with selected classification variables such as, but are not limited to the following:
Use of building—residence, office space, industrial, etc.
Size of building—number of floors, square footage, etc.
Geo-weather zone of location of the building—Northeast, western desert, hurricane zone, etc.
Energy consuming apparatus—dual zone residential, complex HVAC office building, etc.
Occupant Usage Style—gone during the working/school day, home on weekends.
Meta Dimensions:
   Openness—measure of the square footage of opening between adjacent rooms on a given floor,
   Granularity—number of air flow vents per square footage of room, and
   Robustness—sensitivity of inside temperatures to outside temperature (e.g., would be lower with large shade tree coverage and/or high rating of insulation).
Sensitivity to external weather—level of insulation, etc.

Such dimensions along with historical data may support pre-classification of building types with regard to their energy dynamics. This allows Discriminant Analysis to build discerning planes in hyperspace that in turn will rapidly classify a new building into one of n-groups. The Discriminant Analysis canonical equations are:

tᵢⱼ=Σₖ₌₁^{g}Σₘ₌₁ⁿ^{ₖ}(xᵢₖₘ−x_{i . . .} −x(i . . . )(xⱼₖₘ−xⱼ))

### Where:

g=number of groups,

nₖ=number of cases in group k,

n·=number of cases over all groups,

xᵢₖₘ=the value of the variable I for the case m in group k,

xⱼₖ=mean value of variable I for those cases in group k, and

x_{i . . .} =mean value of variable I for all cases (grand or total mean)

Classification then is determined by a linear combination of the discriminating variables. Such a linear equation is calculated in a fashion that maximizes group differences while minimizing variance within a group. Such classification functions are defined by the equation:

hₖ=bₖ₀+bₖ₁x₁+bₖ₂x₂ + . . . +bₖₚxₚ

Where hₖ is the score for the group k and the b's are the coefficients that need to be calculated. A case is classified into the group with the highest score (largest h). The coefficients for these classification functions are derived by the following computation:

bₖᵢ=(n·−g)Σⱼ₌₁^{p}aᵢⱼxⱼₖ

Where bₖᵢ is the coefficient for the variable I in the equation corresponding to group k, and aᵢⱼ is an element from the inverse of the within-groups sum of the cross products matrix. A constant term is also required as is defined by:

bₖ₀=−·5Σⱼ₌₁^{p}bₖⱼxⱼₖ

Once the discriminant functions are developed and stable over a large data set of buildings, they may be used to rapidly classify each new building. This classification may then be used to determine the initial seed values for the learning phase in creating the building-specific energy dynamics model. This can shorten the learning phase and diminish the computational burden overall. The building classification process will also shorten the time and processing load to search for optimal energy management solutions with the use of seeds (starting positions of agents and starting agent behavior).

### 4.3.3 Processing Performance Considerations

A novel approach may include, but is not limited to, four strategies for minimizing the processing load for an implementation:
Using building classification for selecting a seed for the learning phase in developing the building-specific energy dynamics model,
Using building classification for selecting a seed for the agent-based optimization methods in search for the optimal energy management solution,
Using finite-element models to represent partial differential equations in the building specific energy dynamics models, and
Using the automated auction process wherein the Aggregator merely sorts the appliance/devices of all the buildings by their ratio of energy cost reduction divided by comfort-convenience sacrifice.

### 4.3.3.1 Building Cluster Based Seeding for Learning Phase

One of the more processing demanding processes in the approach is the learning phase in developing the building-specific energy dynamics model. The cluster analysis and subsequent discriminant analysis on the parameters for such energy dynamics models will facilitate the identification of buildings with similar energy dynamics models. These clusters and discriminant planes can then be used to select seeds for the learning phase on new buildings. This in turn will shorten the time needed to converge to an acceptable energy dynamics model and reduce the associated processing resources consumed whether they occur on a local PC within a building or on a server cluster at the Central Web Site.

### 4.3.3.2 Building Cluster Based Seed for Optimization Phase

The buildings may be clustered for similarity in their optimized energy management solutions. With the development of effective and valid clusters, discriminant analysis may be used to identify optimization solutions representative of each cluster. These solutions then may be used as seeds for the optimization process on new buildings. This seeding promises to accelerate the time to converge to an attractive solution which minimizes the processing resource consumed.

### 4.3.3.3 Finite Element Analysis for Building Energy Modeling Performance

Finite element analysis may be used to provide a representation of the differential equations used to model the energy dynamics of a building. Finite element analysis produces a number of connected tiles (in n-space) defining a response surface. These tiles are defined by coordinate positions in n-space. These coordinate positions defining the tiles will be kept in a data base in the Central Web Site. This data base of tile coordinate positions will be structured by building cluster type. The energy dynamics models of such building classification clusters may then be built using a finite element analysis (a one-time large investment of compute resources in itself) to approximate the equations in the energy dynamics models. The finite element approach converts the results of exercising a model's equations within reasonable limits for a given building class and matches the outputs with a series of linear surfaces. The combination of these linear surfaces (or tiles) tied together form the complete response surface of the model for that building cluster under certain conditions. This conversion from differential equations to a set of linear surfaces transforms the use of the models for learning, optimization or demand-response to a table lookup process rather than a large number of floating point operations. This will dramatically reduce the computer power required to leverage the validity of the models for real time building energy management and real time negotiations with the Utility Company.

### 4.4 Demand Response Negotiation or Auction Bid Development

### 4.4.1 Real Time Bidding within a Demand Response Regime

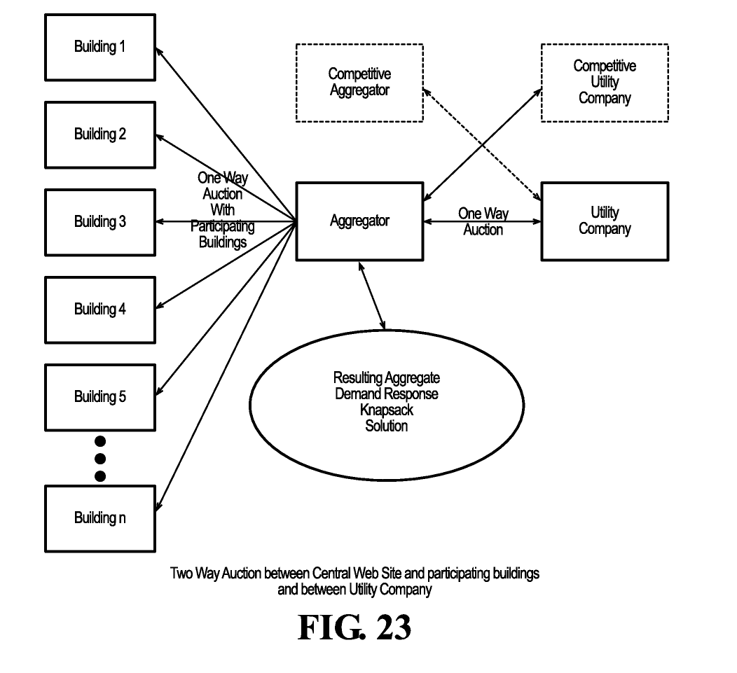

The inventive subject matter contemplates a solution that includes an instance wherein an Aggregator Company could (using the solution through a central web site) represent a large number of buildings in facilitating their demand response contractual obligations with their Utility Company. This real time demand response compliance may be implemented via a negotiation approach or via an auction set up between the Aggregator Company and the utility company as shown in FIG. 23. A negotiated approach involves one buyer and one seller reaching a mutually acceptable bi-lateral agreement through one or a series of interactive offers or bids. Multiple iterations of bids may be involved back and forth between the participants in a negotiation. This could be the case between an aggregator and each of its participating buildings comprising a series of bi-lateral negotiations. In this case this is not an auction in that the bids from the participating buildings are not being compared to each other. The aggregator keeps negotiating with each building for more usage load reduction until the aggregate over all buildings meets the demand response goal. In the negotiated case, all bid offers are accepted by the Aggregator. In the auction case, all participating buildings are bidding against each other. The aggregator accepts some of the better bids and may turn down others. If a building's bid is rejected, they do not participate in the utility cost reduction derived from the demand-response agreement. A negotiation could also be the case with one aggregator and one utility company reaching a bi-lateral agreement.

An auction may involve either multiple sellers or multiple buyers or both (usually called a market). An auction approach could be used if multiple Aggregators (see dashed box in FIG. 23) representing multiple building energy solution management solutions were engaged with the Utility Company. In that scenario, the Utility Company could receive competing auction bids for meeting or exceeding contract terms for their demand compliance agreements from different Aggregators. Another embodiment could include one Aggregator dealing with two or more utility companies for the set of buildings being aggregated.

The Aggregator may be seen to be negotiating in two directions at once. This is shown in FIG. 23 where the Aggregator managing through a central web site negotiates on one side with building owners for their respective contributions to make the energy consumption reduction to satisfy the demand response terms with the Utility Company while on the other side negotiating an offer with the Utility Company. FIG. 23 also shows that gathering available energy contributions from the participating buildings can be seen as a knapsack optimization problem.

The classic knapsack problem is a problem in combinatorial optimization. Selecting from a set of all available objects (each with a weight and a value) to fill a knapsack of limited capacity that provides the greatest value. In this case the total object set available is all the energy consuming devices in all the buildings represented by the Aggregator. Each object has a value in the energy consumption savings over the designated time period and a cost. The cost in this sense is the sacrifice given in terms of each building owners comfort/convenience preference value function. The problem to be solved is determining that combination of devices from all the participating buildings to turn off for how long to add up to something attractive to the Utility Company. The parallel to the limit of the capacity of the knapsack is a limit on the sacrifice of comfort/convenience value offered by the aggregate of the participating buildings. Such a “knapsack limit” is elastic and may be made larger to adjust to differing demand response scenarios. Both PSO and ACO have been proven to be quite adept at solving knapsack problems.

### 4.4.1.1 Stochastic Anticipative Negotiations

All negotiations, either with the participating buildings or with the Utility Company may be time structured, most likely in hourly segments. Hourly is likely appropriate because it is roughly the time period within which turning off an appliance begins to add up to measureable energy cost savings. An hour also works well in that it is a time period during which there is relative stability in the external weather situation. Thus an optimization algorithm may optimize over a coherent segment in time such as six to twelve hours broken into hourly decision regimes. In this case, the optimization problem may be characterized as a stochastic one in that the weather over a six to twelve hour period is only predictable between very wide probability bands as are occupants' energy usage patterns.

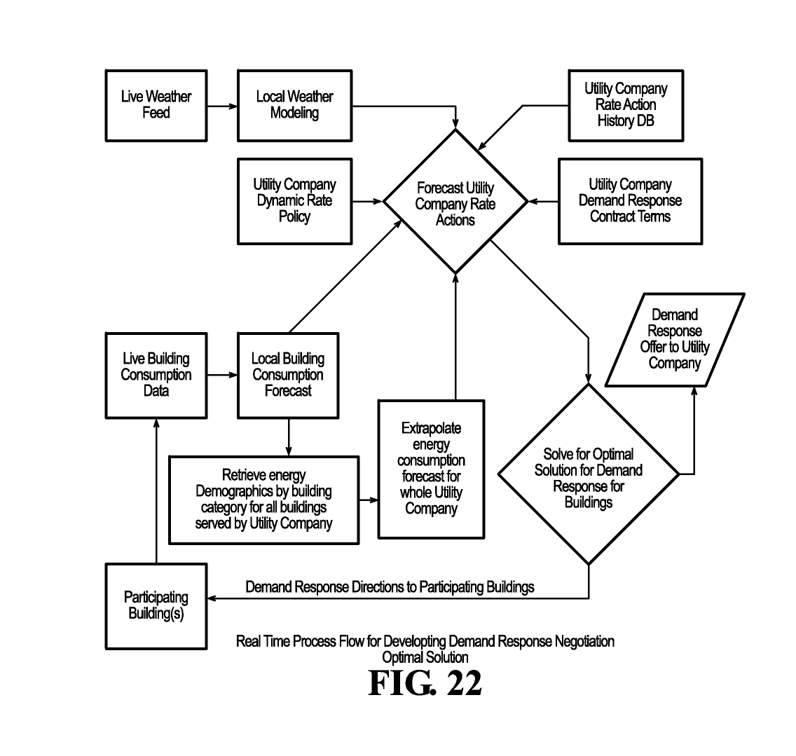

The optimization algorithm may operate on forecasts of the weather, occupants' usage patterns and the rate actions of the Utility Company over the time segment and then determine the optimal energy usage scenario accordingly. These forecasts may draw on historical data stored in respective data bases along with predictive models based on live data gathered throughout the day. A processing flow leading up to a negotiated demand response offer to the utility company is depicted in FIG. 22.

### 4.4.1.2 One Way Auctions

An auction is a mechanism to allocate resources among group of bidders. An auction model may include, but is not limited to the following parts:
Description of the potential bidders—the participating building owner/occupants;
The set of possible resource allocations (describing the number of goods of each type, whether the goods are divisible and what are the restrictions on the goods)—the appliances/devices that could be turned off or down (e.g., lower the temperature on the hot water heater) to contribute to the demand response compliance; and
The values of the various resource allocations to each participant—the “aggressiveness” factor for the demand response bidding for each building to qualify for the Utility rate reduction accompanying the demand response participation

An auction mechanism may be developed that is driven by the value preference functions for each building and modified by the “aggressiveness” factor that reflects the building's respective interest in participating in the demand response contract. The mechanism may be a pivot mechanism in the Vickrey-Clarke-Groves (VCG) model. The version of the VCG model that may be implemented in this energy management solution is a balanced budget option where the sum of the bids must equal the target, in this case the demand response energy consumption reduction agreed upon between the Aggregator and the Utility Company. The VCG auction model is an excellent match for the demand response implementation proposed herein for reasons including but not limited to the following:
VCG auctions may severely tax bidder's computational abilities—not the case in the implementation proposed herein as the automated version leveraging the building's preference function and “aggressiveness” factor provide bids from the local software and tracked by the Central Web Site of the Aggregator and thus face no such computational limits;
Real bidders often face serious budget limitations—not a problem in the case where the value preference function only identifies those appliances/devices that may be sacrificed in the given usage zone; and
The auction mechanism may force the winning bidder to reveal too much information—not in the automated case where the Aggregator knows the value preference function of all building bidders and a given building only bids where they are willing to sacrifice in comfort/convenience.

The negotiation that goes on between the Aggregator and the participating buildings may have two modes: automatic and owner decision based. Both automated and owner decision based modes are auctions to allocate resources among a group of bidders. In this case the resource being allocated is reduced energy costs implemented via lower utility rates. What is bid is energy consumption reduction (and corresponding comfort/convenience sacrifice) by each building.

An embodiment of the automatic auction could be an “English” Auction with ascending bids from the buildings for deeper and deeper energy consumption reductions accomplished through deeper and deeper sacrifices in comfort/convenience. The automatic bid may be also a “public” as opposed to “private” bidding process in that the Central Web Site may “know” all the bids produced by the local software representing preference value functions of all the buildings. A unique aspect of implementing the automated bidding process from each building is the “aggressiveness” factor that may be included in each buildings comfort/convenience value function. Each building owner/occupant may define through—the value function development—the level to which they desire to be aggressive in responding to demand response opportunities. This aggressiveness may be defined in terms of the comfort/convenience sacrifice the owner/occupant would offer in order to qualify for a given level of utility rate reduction. This may be different for each building and will thereby create a true competitive auction situation that may also be automated.

The automatic mode may be implemented by the central web site software querying each building's comfort/convenience preference value function to find which appliances/devices could be turned off with the least comfort/convenience value lost while achieving the greatest aggregate energy cost savings. The central web site algorithm could sort the list of all appliance/device objects of all the buildings by their ratio of energy cost saved divided by preference value sacrifice. The sorted objects could then be added to the demand response “knapsack” until they add up to energy savings compliant with the demand response terms negotiated with the Utility Company.

This is a novel feature of a fully automated real time ongoing auction between the central web site and the participating buildings is a unique feature of this approach. This places no burden on the owner/occupants to be directly involved in the real time demand response decision yet the auction bids regarding their building is based on their comfort/convenience value function, their lifestyle usage of the building (at the day and time of the bidding) and their bid aggressiveness factor.

The owner decision based option may be written into the contract between the building owner and the Aggregator providing the energy management solution. This could stipulate the level of comfort/convenience sacrifice resulting from the software turning an appliance/device off that would trigger a communication to the owner/occupant. This communication is basically asking permission to implement the turn-off transaction of the designated appliance/device. This software generated communication may take place in one or more of a number of media depending on the preference of the owner/occupant including, but not limited to, phone message (home or cell phone), email, text message to phone, instant message to phone or blackberry, etc.

A mechanism may be implemented in the Central Web Site software to implement the automated bidding from the buildings. This mechanism may provide the set of rules to govern the interaction of the participants. The mechanism may be designed to accomplish a zero sum net budget between the aggregate of the bids from the buildings and the peak demand goal necessary to accomplish the lower utility rate structures. The mechanism may be structured to classify bidding buildings by “type.” At least two dimensions could determine a building's bidding type: size of annual energy costs (thereby indicative of the potential size of the daily energy consumption cost reduction) and the aforementioned bidding “aggressiveness” factor.

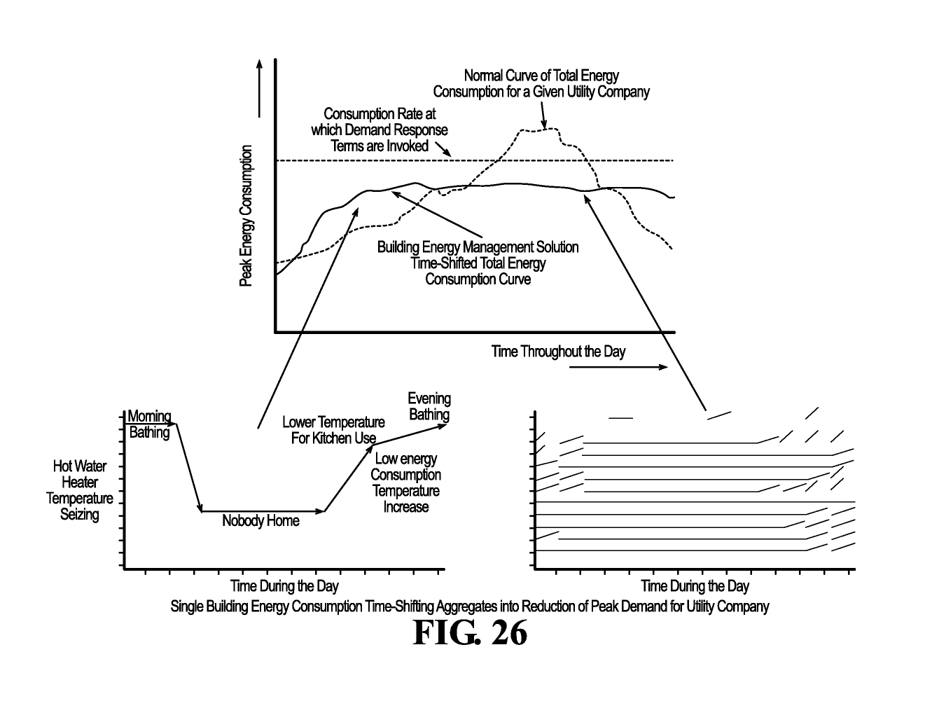

A goal of the mechanism is illustrated by FIG. 26 wherein by managing the aggregate time based consumption of all the participating buildings, the load on the utility company is shifted such that the peak demand threshold for invoking higher utility rates is never exceeded.

### 4.4.1.3 Two Way Auctions

A two way auction may occur in the case where there are either two or more Aggregators or two or more Utility Companies (see FIG. 23). The aggregator is receiving auction bids from participating buildings (similar to the one-way auction) and aggregating them into a competitive auction bid (against a competitive Aggregator) to the Utility Company for the second one-way auction thus creating a two-auction situation. Conversely the Aggregator could be receiving competitive auction bids from two or more Utility Companies. In this latter case there is a dual knapsack problem to be solved in that not all the participating buildings would be receiving electricity from both Utility Companies.

### 4.5 Implementation Approaches

A number of steps could be necessary to install, set up, test and deploy the Building Energy Management System embodiments. These steps may include installing hardware (controllers, sensors), netware (local wireless, etc.), software (local software) and setting up accounts on the Central Web Site and in some instances Demand Response Accounts either directly with the local Utility Company or through an Aggregator.

### 4.5.1 Single Building Implementation

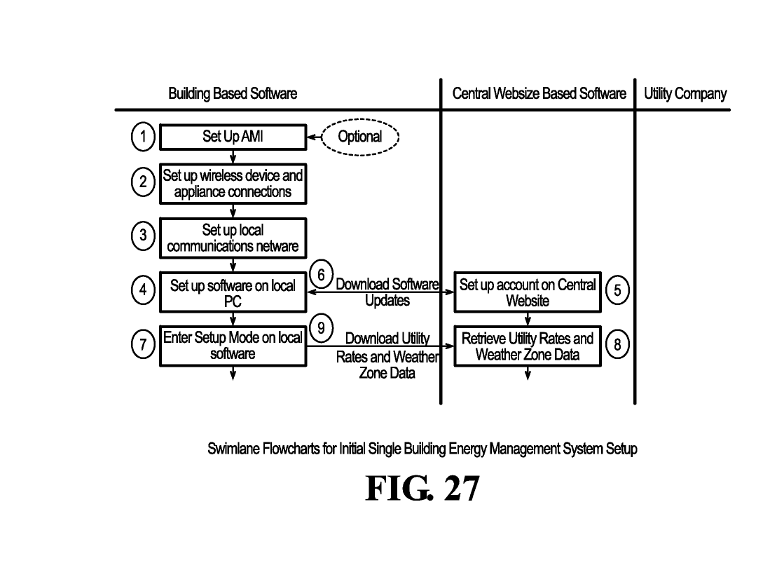

Exemplary steps of the single building implementation are depicted in FIGS. 27 through 29. As an example, this implementation embodiment as defined herein is limited to applying the local and Central Web Site software to the efficient energy management of a single building without leveraging information from other buildings or collaboration with other buildings or aggregation with other buildings.

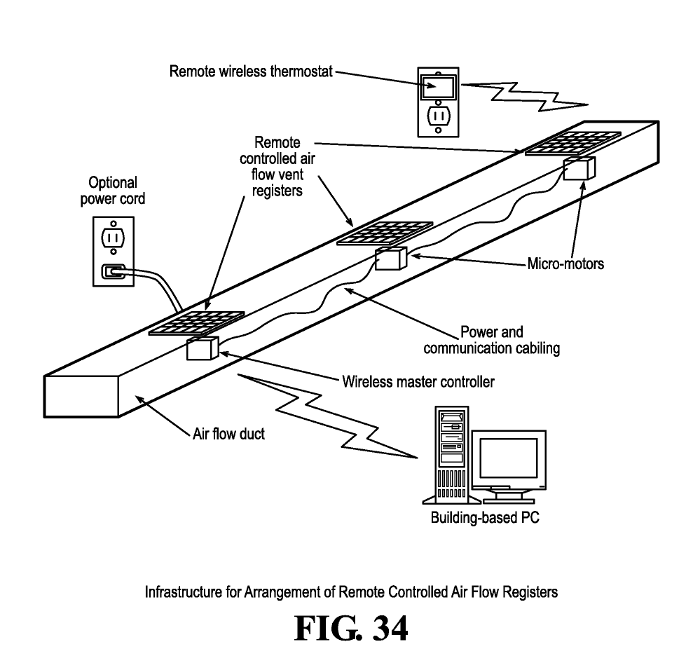

In a possible embodiment, the building energy management system consists of a synchronized set of controllable air flow vent registers. FIG. 34 illustrates a possible implementation of this set of vent registers. Each level of opening controlling the flow of air through a given vent register is controlled by micro-motor. Control directions to the micro-motor may be provided through wireless communications or cable connection (as shown in FIG. 34) from a master controller which may be wired or wireless. The wired or wireless communication link may be used to provide both control communications and/or power to the remote vent registers. The master controller may be plugged into a wall outlet to provide electricity to some or all the connected vent register micro-motors. Alternatively, the micro-motors may be battery operated. The master controller may be connected through the building wireless network to the building-based PC.

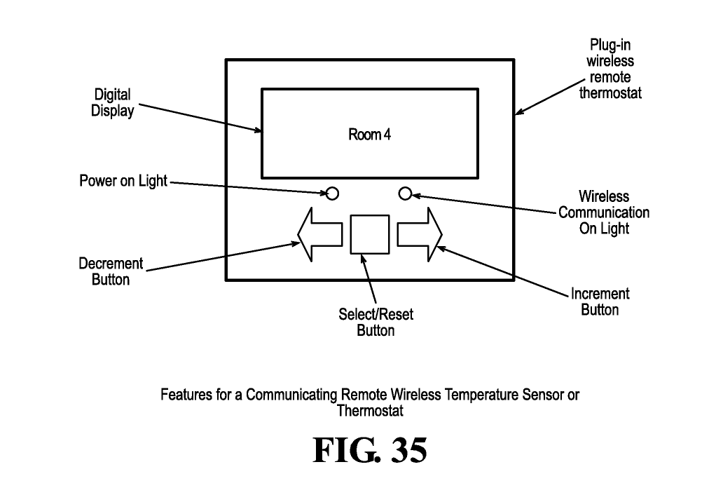

In a possible embodiment, an element for the vent-control subsystem is a thermostat (see FIG. 34 and FIG. 35). For example, the thermostat may be a remote wireless thermostat. While wireless thermostats are common in today's building energy control, they primarily provide wireless communication from a remote handheld controller to the thermostat. They are not wireless from the temperature readings to appliance/device controllers. Furthermore they do not facilitate the re-location of the remote wireless thermostat from room to room depending on season, time of day and occupant usage pattern. The wireless remote thermostat according to the inventive subject matter may do this and more. For example, the thermostat may be designed to plug into any wall unit and allow the user to identify the room in which it is located in one two fashions:
Use a series of buttons on the face of the thermostat (see FIG. 35) to identify the new room location by room number as specified in the original set up process; and/or
Use the GUI on the energy management software on the building-based PC to identify the new room location using the same room numbering sequence.

In one exemplary embodiment, each vent micro-controller would also be numbered and identified with respect to room location in the same fashion. Furthermore, each vent register and corresponding micro-controller would be identified with regard to the location with an identified room as a single room could have two or more vent registers. These locations would be specified as to feet from each wall in the room during the original building specification process. The master controller may consist of a micro-processor with software loaded in a PROM (programmable read only memory) or similar low cost storage. This software in the microcontroller would take temperature information from any remote wireless thermostats, the target temperatures for each room from the building-based PC (via e.g., wireless connection) for other computer systems and then send control directions to each remote vent micro-controller. These control directions may then be based on a building specific energy dynamics model loaded in the building-based PC. The building specific model would have been developed during the learning mode in the original setup and installation.

The software logic in the master controller would record the prior control directions to those vents located in rooms without a thermostat and then use the building-specific energy dynamics model to estimate the temperature in a given room. This lowers the cost of the overall installation eliminating the need for a thermostat in each room. An ultra-low cost version of the energy management system can be implemented using the software in the micro-controller alone. In this simple low cost installation the room and vent identification and location information may be specified in the PC and then downloaded to the micro-controller (either by wireless or RS-232). The master controller would have enough built-in software logic and storage capacity to build a simple room-by-room energy dynamics model. This energy dynamics model would only have to correlate temperatures in other rooms with a temperature reading in one room. This master controller logic would always be in learning mode. Early in the installation of this low cost implementation, the master controller learning mode would benefit and converge to a stall mini-energy dynamics model if the occupants moved the wireless thermostat from room to room frequently allowing a comparison between forecasted and actual temperatures under a variety of recent air vent control histories. This room-to-room temperature forecasting model can be developed through simple correlation or neural networks.

The master controller then would take in usage patterns and corresponding target temperatures for each room as originally specified on the building PC during setup. It would then use the recent (e.g., last hour) control directions, live temperature feeds from any wireless thermostats and the room temperature forecasting model to determine the next set of control directions to each of the micro-controllers managing the each of air flow vents. This implementation of the concepts presented herein would allow improvement in energy management efficiency and some lowering of annual energy costs with a minimum of initial investment. All this would be enabled by loading simpler versions of the algorithms discussed in this application into the master controller software.

### 4.5.1.1 Single Building Solution Set Up

A single building solution embodiment set up and installation is depicted in FIG.

27. The FIG. is structured as a “Swimlane” chart depicting activities with the three major actors—the single building, the Central Web Site, and the Utility Company—being shown in vertical columns or “lanes”. The sequence of flow is shown in task boxes or information flow arrows which are numbered (circles with numbers in them) to show the typical sequence. FIG. 27 then shows the first nine steps in the set up and installation of the single building instance. These steps may include, but are not limited to, the following:
Step 1—Install AMI metering and set up communication accounts designating where energy consumption data should be sent possibly including local software, the Utility Company, the Central Web Site and/or the Aggregator Company. This step is optional and not necessary for the Building Energy Management System but may improve optimization through semi-real-time feedback on how various appliance settings impact actual energy consumption levels and corresponding costs.
Step 2—includes the installation of any hardware devices such as controllers and/or sensors. This would include the installation of wireless controllers for hot water heaters, wireless remote-controlled air flow vent registers, remote wireless thermostats, wireless control over HVAC equipment, etc.
Step 3—installing, testing and initializing the local netware (wireless, cabling, hybrid, etc.) including connecting to all the local controller and sensor devices. This is the first step that includes loading netware support software on to a local processor such as a PC in the building.
Step 4—installing, testing and initializing the local Building Energy Management software on a local processor such as a local PC. This includes round trip communication testing of the netware to determine the remote readings may be gathered by the local Energy Management Software from the remote sensors and AMI. This includes testing that control signals may be successfully sent to the appliance/device controllers to be able to control them by the Energy Management Software through the installed netware. This also includes setting up the local Energy Management Account with owner's information.
Step 5—the local software may then be used through a common Internet connection to contact the Central Web Site (shown in the middle lane in FIG. 27) to set up a user account.
Step 6—after the user account is set up any software upgrades and patches may be downloaded to update the local software installed on the local processor. In setting up this account the user could identify the basic building type and the account features (e.g., Demand Response, AMI, etc.) to be included in the user account.
Step 7—with the account features determined and downloaded to the local software, the local software then builds the setup script including identifying which links (e.g., AMI, local Utility Company, Aggregator, etc.) it needs to establish and which further set up and installation steps (e.g., neighboring building data sharing) are to be set up; this list of steps is then presented to the user in the proper sequence to be carried out, tracked and logged.
Step 8—the address of the building and the identification of the applicable Utility Company will cause any relevant (and ordered) data feeds such as weather and utility rate changes to be implemented into this account at the Central Web Site.
Step 9—relevant and ordered data stream data will then begin to be downloaded into the local software on regular intervals and/or on alert-driven specifications.

These first steps may complete the initial phase of the system installation and user account setup.

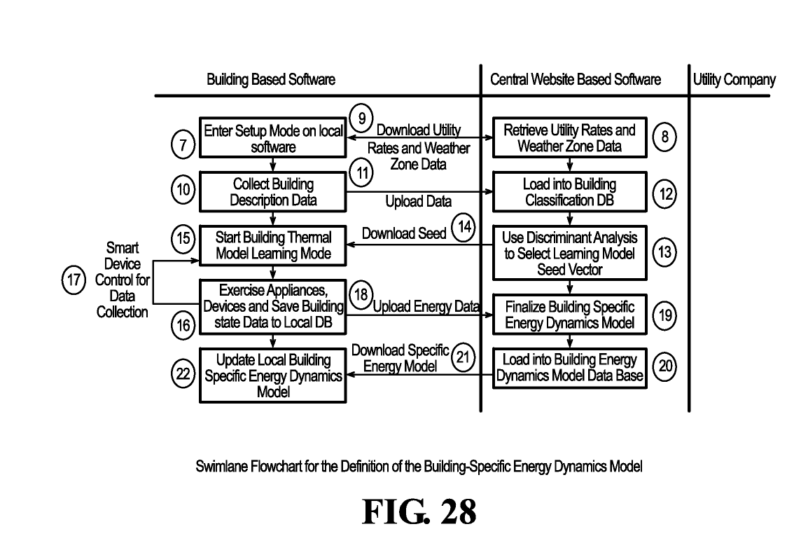

FIG. 28 illustrates the next group of implementation steps (10-22) and these are focused on developing the building-specific energy dynamics model via the learning mode for the new account. The last few steps (7-9) from FIG. 27 are repeated in FIG. 28 for continuity purposes with white (as opposed to gray) numbered circles. These steps may include, but are not limited to, the following:
Step 10—this mode of the local software may include using the GUI to describe the basic characteristics of the building (office, single family, industrial, etc.) and the description of the appliances/devices (by make and model) the user wishes to control. This description may include information regarding the layout of the rooms, doors, windows, etc. The description may also include the identification of the air flow vents by type, size and location. Any appliance/device identified as remotely controllable could cause the netware to establish and test a link if that hasn't happened already.
Step 11—the data description data may be uploaded to the Central Web Site.
Step 12—the uploaded data for that building may be stored in the Building Definition Parameters Data Base.
Step 13—discriminant analysis may be applied to the uploaded building definition parameters to determine what building classification it falls within and whether it is a good enough match to that classification archetype to be able to leverage a seed parameter set with which to start the learning mode on the local software.
Step 14—if a good enough match is identified, then the seed data for starting the learning mode could be downloaded. This seed data could represent the best guess of the energy dynamic model parameters for that specific building based on its membership in a classification archetype.
Step 15—the user may be alerted to the download via email or other mode of communication and instructed to start the learning mode to develop the building-specific energy dynamics model. The user may be instructed that the software (while in the learning mode) would control the appliances/devices/HVAC etc. through a number of extremes in order to measure the resulting energy consumption and resulting building state (e.g., temperatures in each room).
Step 16—the learning mode of the local software then uses the seed parameters to determine the control instructions to send to each appliance and device in a sequence pattern and begins to collect the resulting data on an appliance/device state (e.g., temperature of hot water heater over time) and building state data such as resulting room temperatures and energy consumption levels and resulting costs.
Step 17—is a feedback loop into the learning mode wherein it determines a new set of appliance/device control instructions to achieve convergence to a robust energy dynamics model parameter set for that specific building. This sequence of steps 15-17 may take hours or days before the learning mode is completed depending on the complexity of the building.
Step 18—the resulting room temperatures, appliance/device state data along with the learning mode control instruction sequences may be uploaded to the Central Web Site. An implementation option, particularly if the provided local PC is underpowered, is for the server farm at the Central Web Site to handle the learning mode processing with the local PC merely distributing control instructions and gathering/uploading resulting state data.
Step 19—the learning mode converges to a building-specific energy dynamics model that successful forecasts the building's response to a set of external weather conditions and a sequence of appliance/device states throughout the course of a 24 hour day. The final model may take a number of forms depending on the implementation alternative:
   full energy dynamics model based on differential equations,
   finite element equivalent model of the same set of differential equations, or
   merely a state-space model with appliance-device control scripts depending upon the usage mode (day of week and time of day) and external weather.
Step 20—the set of parameters that define the final building specific energy dynamics model are then stored into the Data Base of Building-Specific Energy Dynamics Model Parameters.
Step 21—the final Building-Specific Energy Dynamics Model Parameters will be downloaded to the local software for use.
Step 22—the energy dynamics model parameters are installed in the local software for use in managing the energy consumption of the building thus completing the learning mode phase.

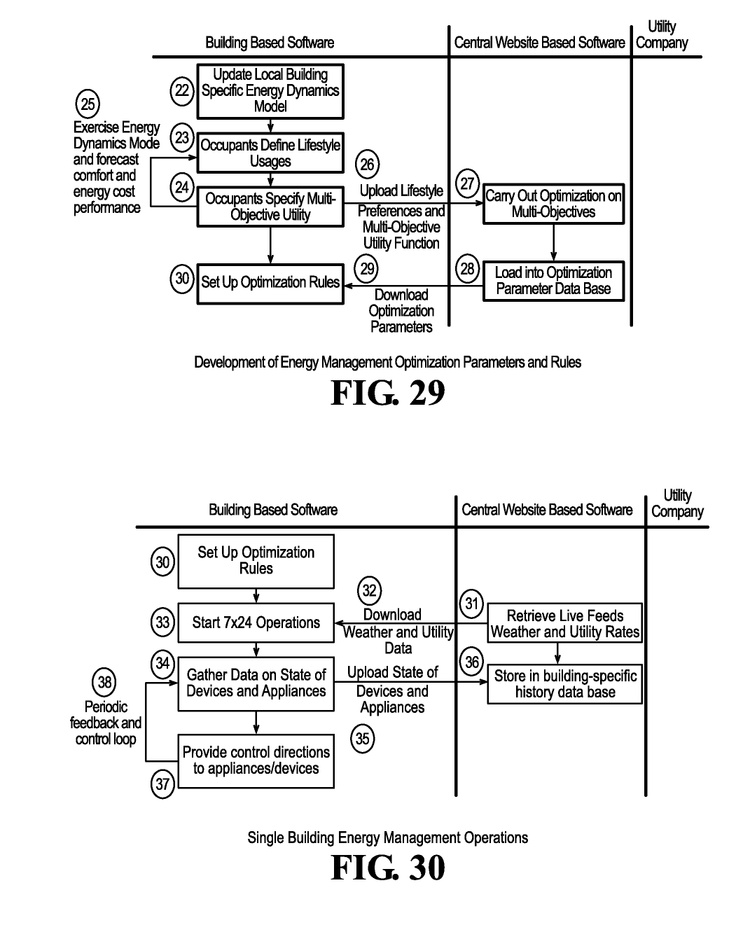

The next sequence of steps 23-30 involves the development of the user-specific lifestyle usage patterns, multi-objective value function and resulting energy management optimization parameters and rules. FIG. 29 illustrates a Swimlane flow for these steps in a setup of the single building application of the Building Energy Management System and solution. The connecting step 22 from FIG. 28 is shown in a white circle in FIG. 29. These steps may include, but are not limited to, the following:
Step 23—the owner/occupant uses the GUI of the local software to define the usage pattern of the building. This process starts with the user identifying blocks of time during the typical weekday or weekend day wherein the building usage is consistent within that block of time or a “usage zone”. An example would be 8 AM-3 PM wherein the complete family of a residence building is out of the building either at work or school. This usage zone would be labeled “unoccupied”. Other typical usage time zones could include, but are not limited to, “morning preparation” (showering, eating, leaving), “evening relaxation” (TV watching, reading, etc.) and “weekend day” (people coming and going with low usage in rooms except for family room). Similar usage patterns and zones may be defined for office buildings, industrial plants, etc.
Step 24—once the lifestyle usage patterns for the building have been determined, the user would use the GUI of the local software to determine their multi-objective value function for the use of the building. This interactive software process may ask the user a series of questions aimed at determining the user's specific value function reflecting desired tradeoffs between comfort and convenience of building usages vs. annual energy costs. The questions may be structured to determine the value function parameter values for each usage zone of the building. Once the initial value function parameter sets have been determined for each usage zone, they may be used in concert with the building-specific energy dynamics model and the utility company's rate structure to forecast energy cost reductions. Once the basic value preference function is defined for a building, a series of questions may be posed to determine the level of aggressiveness the owner/occupant wishes to leverage in demand response situations. A more aggressive demand response value function will result in greater savings in annual energy costs at the sacrifice of comfort/convenience.
Step 25—the local software may use the building usage zone definitions, local weather data, the building specific energy model and the usage zone based value functions to simulate the use of the building including its appliances/devices for a year. This annual usage simulation would then leverage the historical utility bill data and the utility rates to forecast the reduced annual utility bill. The user may then be provided with a screen report or printout identifying largest sources of energy bill reduction and largest remaining opportunities. The user may then be offered, but not limited to, two modes from the local software: 1.) annual energy cost target driven solution and 2.) value function refinement via further selected cost-comfort tradeoff questions. The user uses either or both of these modes until they are satisfied with the forecasted annual building energy cost and corresponding building usage rules built into their value function.
Step 26—after the user is satisfied with the results of step 25, the resulting building usage definitions and value function rules and parameters may be uploaded into the user's account in the Central Web Site.
Step 27—at this point, the Central Web Site may use the building specific energy dynamics model, the usage zone definitions and the owner/occupant's value function to carry out the energy management optimization process. It is here that the meta-heuristic optimization methods such as PSO, Irving-Wolfhound, ACO, etc. may be applied to seek the optimum control of appliances/devices in the building to minimize annual energy costs while satisfying the usage driven comfort-convenience value function. This optimization process may be seeded with optimization solutions based on the usage category, the weather zone category, the building energy dynamics model category, and/or the building classification category. The result of this optimization process may be an operational model parameter set, a set of input-state-output rules and/or a finite element response surface table.
Step 28—once the optimization process has converged to a satisfactory solution, the results may be loaded into the Optimization Parameter Data Base.
Step 29—the results of the energy management optimization process may then be downloaded into the local software for 24 hour a day operational implementation.
Step 30—the local software may install the optimization solution and exercise the appliance/device controls and query the sensors to make sure the physical plant matches the assumptions in the optimization solution. If a mismatch occurs, an error message may be sent to both the building owner and the Central Website help desk. Often these error messages may be resolved with turning a device on or resetting a sensor or controller.

Upon the satisfactory (no unresolved error messages) completion of Step 30, the energy management solution may be ready to start full automated operations.

### 4.5.1.2 Single Building Solution Operation

Different embodiments of the inventive subject matter may also have one or more of, but not limited to, the following optional components: local energy usage display, local energy management, energy usage email, and remote manual energy management that may be resident in the software in the local PC and provide additional features to the user. Furthermore, the computerized process associated with the present invention system may also have one or more of, but not limited to, the following optional executable steps:
Gather data from building energy consuming devices and calculate average usage statistics by time of day and day of week.
Display statistical usage data on local PC screen or email to a remote address.
Compare usage statistics and cost data with other buildings of similar size and layout in similar weather zones.
Support web based retrieval and viewing of latest energy consumption data.
Send an email to user's specified address regarding anomalies in energy consumption levels or patterns or anticipated change in the Utility Company's rate structure.
Support web based remote control of building energy consuming devices.

FIG. 30 shows the steps involved in the single building operations of the energy management system. FIG. 30 shows the connective step 30 (white numbered circle) and steps 31 through 38. These steps may include, but are not limited to, the following:
Step 31—the Central Web Site collects local weather data and any utility rate changes from data streams into the Central Web Site.
Step 32—streaming data relevant to the specific building is downloaded to the local software either periodically (e.g., every 15 minutes) or on an alert-driven “significant change” basis.
Step 33—the local software uses the updated weather and utility rate data to update its system state vector and then the optimization rules interpret the proper directions to send to the appliance/device controllers and any email alert messages to the building owner/occupants.
Step 34—data is gathered from the sensors and controller feedback loops on the state of the building (e.g., room temperatures) and appliance/devices (on/off, etc.) periodically and is fed into the state vector of the energy dynamics model for the building.
Step 35—the building state vector along with forecasts of appliance/device states (e.g., cooling hot water temperature), forecasts of the local weather and forecasts of upcoming building usage states are used to update the planned optimum controller directions (control vector).

### 4.5.1.3 Single Building Solution Continual Improvement

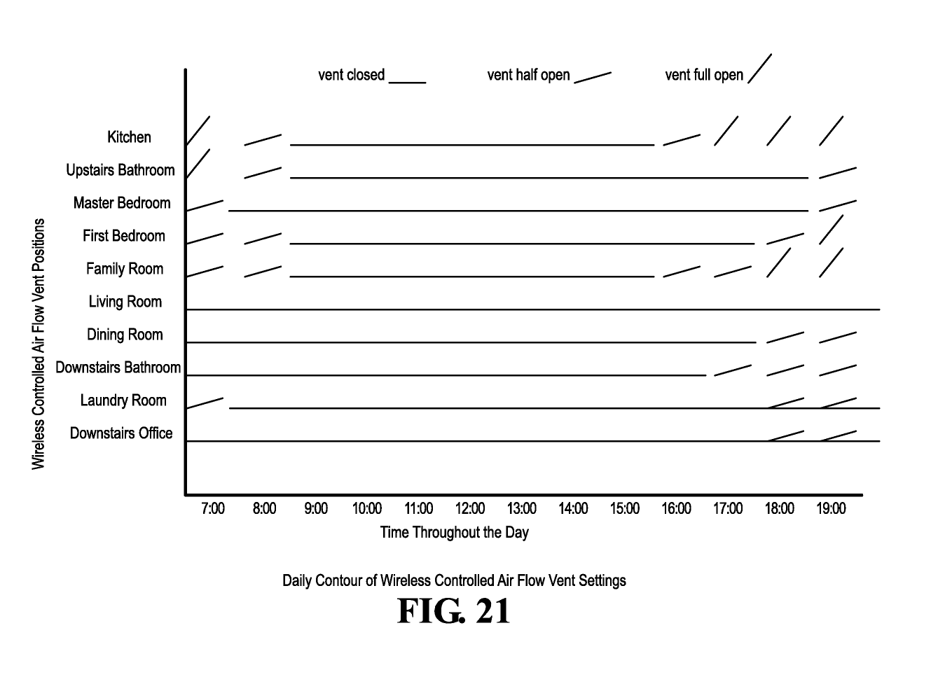

The creative material presented herein facilitates continual improvement with its use with single or multiple buildings. This is inherent in the nature of the modeling, estimation and optimization techniques integrated into the overall solution. FIG. 30 illustrates the flow of information, processing and updates that may go on periodically and continuously with the implementation of the single building energy management solution. As before, the connecting steps (34, 35 and 36) from the prior process flow diagram (FIG. 29) are shown as white numbered bullets. The tasks in FIG. 30 may be repeated periodically and continuously once the single building solution is set up and operating. These steps may include, but are not limited to, the following:
Step 39—the user may always update their account information including building description (e.g., addition of a new appliance), usage zones (e.g., summer schedule for children), value function (e.g., want to accomplish more savings in energy costs), alerts, etc.
Step 40—any changes the user makes and submits may be uploaded to their account at the Central Web Site.
Step 41—user submitted changes once logged and stored on their Central Web Site account may assess for items they impact and therefore should be updated accordingly. For example, the addition of a new appliance (e.g., refrigerator in a finished basement) needs to be reflected in an update to the energy dynamics model (Step 42) and the energy management optimized solution (Step 50).
Step 42—ongoing data collection from the sensors in the building may be stored in the users account (Step 36). This data may be analyzed—forecasted vs. actual—to determine if any of the models and processes need to be updated and improved. One such model update process is the building specific energy dynamics model. The energy dynamics model might predict that with a given starting room temperature and control directions to HVAC and air flow register positions (see FIG. 21) that a forecasted room temperature will result in 30 minutes. That predicted temperature may be compared with the actual resulting temperature from the historical data file.
Step 43—An update to the energy dynamics model is warranted if the error gap between forecasted and actual room temperature is too large. Periodically (e.g., monthly) the complete sensor history file may be used to refine the energy dynamics model to make it more valid and useful.
Step 44—once the energy dynamics model is refined, the updated model may be downloaded to the local software at the building.
Step 45—the downloaded update to the building specific energy dynamics model may be installed, tested and launched.
Step 46—another model which may be updated by comparing forecasted vs. actual data is the local weather model.
Step 47—the local weather model is focused on a small area such as a few neighborhoods (e.g., ZIP+4) and relies on an empirical model combined with the national, statewide and city based weather forecasts from the weather data stream. This micro-weather model may be updated as frequently (e.g., monthly for a new area, particularly to reflect each season). It is expected that the empirical model will stabilize once the data gathered covers multiple years from multiple participating buildings and an annual update will suffice.
Step 48—the updated micro-weather model may be downloaded to the local software.
Step 49—once downloaded, the micro-weather model may be installed, tested and launched for 24×7 use.
Step 50—one of the advantages of using a meta-heuristic approach for determining the best energy management solution for a given building is that it may always be improved upon. The PSO, Irving-Wolfhound and ACO approaches may be re-processed to continuously seeking better and better solutions. The only limits for this continual improvement process are processing power and time. Monthly updates to the energy management solution may be expected for a new building account. Any changes to the building specification, usage pattern, user value function could also generate a re-optimization process.
Step 51—once a significant improvement has been identified, the building specific solution may be replaced with the new solution in the user's account at the Central Web Site.
Step 52—the improved energy management solution may be downloaded to the local software.
Step 53—the downloaded energy management solution may be installed, tested and launched for 24×7 operations. The improved weather micro-model, improved building-specific energy dynamics model and improved energy management solution could facilitate further energy cost savings at the same or improved comfort-convenience usage of the building.

### 4.5.2 Multi-Building Implementation

### 4.5.2.1 Multi-Building Solution Set Up

Each new participating building could undergo a set up and installation process as depicted in FIGS. 27, 28 and 29. The greater the number of participating buildings the greater the energy management operations data base upon which to draw. As the building classification process gets more robust, the learning seed parameters get more efficient, and the local weather micro-forecasting gets more accurate, the energy management solutions for each building type could get more cost-effective.

### 4.5.2.2 Multi-Building Solution Operation

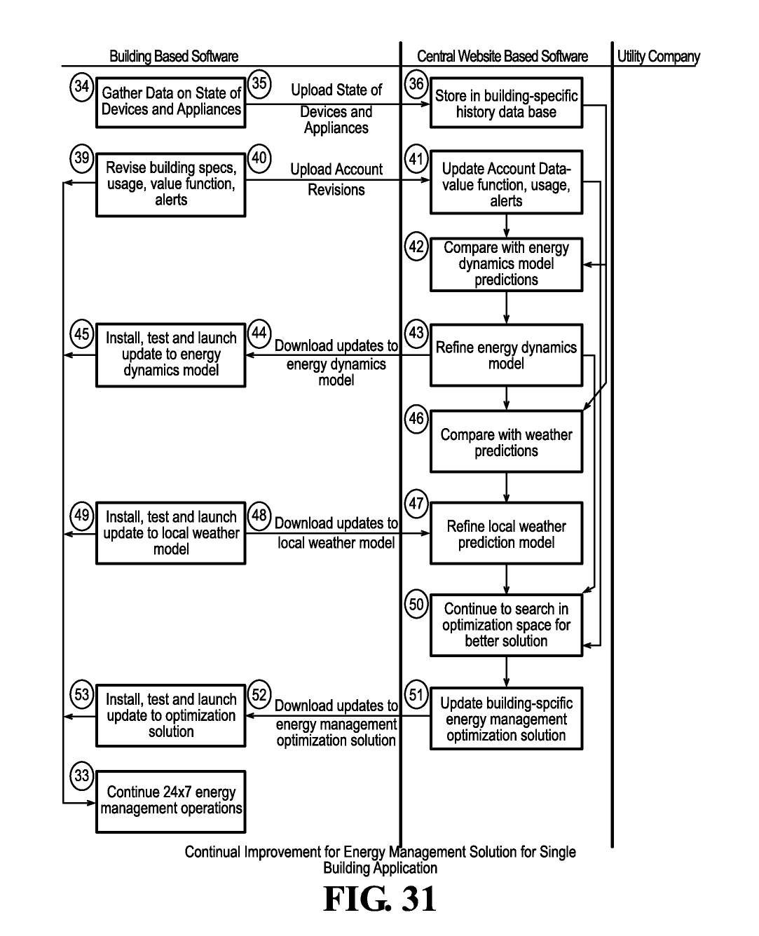

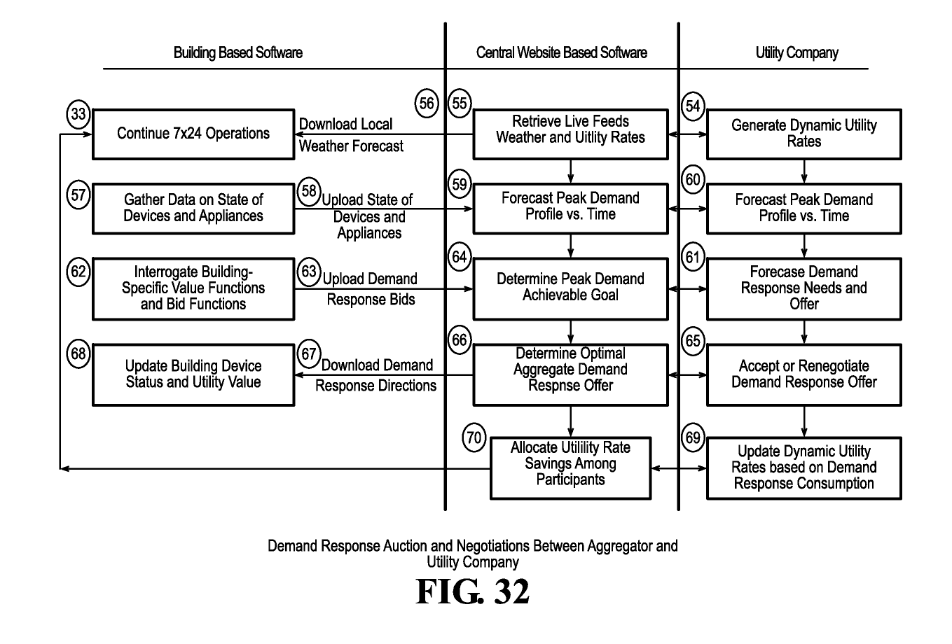

A major advantage of the multi-building solution is the opportunity for the Central Web Site to act as an Aggregator and represent energy consumption of all the buildings in real time negotiations or auctions with the local Utility Company. FIG. 31 depicts a Swimlane flowchart for the multi-building solution represented by an Aggregator. The flow of steps between the individual buildings, the Central Web Site in the role of Aggregator and the Utility Company may include, but are not limited to, the following:
Step 54—the Utility Company may continually assess its needs and opportunities to invoke rate changes.
Step 55—Central Web Site may continually retrieve live feeds from both the Utility Company and the weather data stream. It could process the national weather forecast into micro-forecasts for participating buildings and neighborhoods.
Step 56—forecasts of pending changes in the weather and Utility Rates may be downloaded into the local software at each building.
Step 33 (continuation Step from FIG. 30 shown as white numbered circle)—the continuous operations of the local software at each building takes the downloaded updated forecasts for local weather and operational Utility rates into the periodic decisions for managing the energy consumption patterns of the installed appliances/devices.
Step 57—the local software may gather data on the existing and planned states of the appliances/devices for the forward planning period (e.g., six hours).
Step 58—the appliance/device state (present and planned) data is uploaded to the Central Web Site.
Step 59—the Central Web Site may forecast the weather and the planned appliance/device usages from all the buildings to forecast the aggregate consumption profile for a period (e.g., the next six hours). Included in this forecast may be an estimate of the magnitude and timing of the peak consumption for the participating buildings and then for the total coverage of the Utility Company. The forecast for the total coverage of the Utility Company may rely on an extrapolation of the demographics and density of all the buildings served by the Utility Company by building classification type. Using measurements of energy consumption on the Aggregator's participating buildings by building type and multiplying by the total number of buildings of each type serviced by the Utility Company may estimate the total energy demand for that Utility Company.
Step 60—the Utility Company may also be tracking aggregate demand (without the detailed knowledge of the planned appliance/device usage enjoyed by the Aggregator's Central Web Site) and may attempt their own forecast of total consumption by time including the magnitude and timing of peak demand. The relationship between the Aggregator and Utility Company may include an agreement to exchange these respective forecasts to collaborate towards the most accurate peak demand forecast.
Step 61—the Utility Company may use its forecast of peak demand to issue demand response request to the Aggregator.
Step 62—each building may assess its consumption reduction opportunities (automatically or with user assistance), its planned upcoming usage, its value function and its bid aggressiveness factor and develop demand response bids in the form of offers to turn off or turn down (e.g., lower the temperature of the hot water heater) appliances/devices over the upcoming six hour period.
Step 63—these response bids from each local software may be uploaded to the Central Web Site for the Aggregator to accumulate.
Step 64—the Aggregator may use the details of the status and planned usages of the appliances/devices incorporated into the response bids from each building along with multiple micro-weather forecasts to determine the best achievable response to the demand request from the Utility Company. This step may also be interactive with the Aggregator going back to all or selected buildings (based on a ranking of demand-response bid aggressiveness factors) for increased auction bids. The Aggregator could then formally (under the terms of the contract) make a demand-response offer (on behalf of all the participating buildings) to the Utility Company.
Step 65—the Utility Company may then accept or counter the demand-response offer from the Aggregator based on its own peak demand forecast (which might differ from that of the Aggregator).
Step 66—once an offer from the Aggregator has been accepted by the Utility Company, the Aggregator could accept the utilized bids from the buildings necessary to deliver the negotiated demand smoothing and reduction in peak demand.
Step 67—the Central Web Site could then download the directions of the accepted demand-response bids to the local software for each building.
Step 68—each building then could incorporate their respected accepted demand-response bids into their planned control directions to their appliances/devices thus implementing the negotiated demand smoothing and eventually lowering of the peak demand.
Step 69—the Utility Company may increase, decrease or maintain its utility rates based on its contractual agreements, published rate policies and the actual demand smoothing and peak demand accomplished. Any changes in utility rates may be communicated to the Central Web Site.
Step 70—any changes in utility rates influenced by the demand-response bids from the buildings may be allocated as savings to each building. In some implementations, these savings may be allocated according to the level of contribution made by each individual building to the demand smoothing and peak demand reduction.

### 4.5.2.3 Multi-Building Solution Continual Improvement

Similar to a single building system's propensity to improve over time and use as discussed in section 4.5.1.3, a multi-building solution is likely to improve over time and use as well. Also, the energy management optimization process for each incremental building promises to discover newer and better energy management solutions. These solution improvements may be back-implemented to similar buildings in similar weather zones for further energy management improvements with little to no additional effort or incremental investment of time/money on the part of the building user/managers.

One embodiment utilizes a meta-heuristic optimization algorithm in which the optimization solution gets “smarter,” i.e., converges faster using less computer resources to the best energy management solution with each building to which it is applied. In this fashion, the meta-heuristic optimization algorithm will continue to get better and better and therefore will continually increase its body of data with each day, week, and month it is in use. This optimization improvement process will be further accelerated with the identification and classification of robust building types with highly similar energy dynamics and energy consumption patterns.

Another benefit of the multi-building implementation is the opportunity to develop micro-weather models for buildings in common local weather zones. Using multi-dimensional correlation or regression analysis will compare data such as room temperatures from each building vs. the national outdoor temperature measurement for that local. With enough data, this will allow the empirical accounting for weather influences of shade trees, wind flow patterns over and around hills, etc. A more accurate estimate of the outdoor temperature on each exterior wall for a specific building will facilitate a more cost-effective control of HVAC, remote controlled air flow vents, etc. to control room temperatures to target values.

In certain embodiments, user specific, building specific, and/or facility specific parameters and other data, as obtained from any of the foregoing algorithms or user inputs may be stored locally or in a remote computer system. For each user there may also be a stored set of energy consuming devices that are configured with interfaces for network data communications with a utility provider computer system, namely a party that provides electrical power, or other data signals for controlling electrical power, used to power the devices. The utility provider may be allowed to control the user's device according to a predetermined profile for the user. The control may for example be to turn-on/off power to a given device or to adjust power levels to a given device. The profile may provide to allow control based one or more of the following parameters: time of day, aggregate usage levels across a predetermined grid of users or across one or more devices of a particular user.

In some embodiments, the Corporate Website compiles and manages user profiles and aggregates profiles. A predetermined set of profiles may be aggregated and offered to a utility provider in exchange for monetary or other economic consideration and control of user devices is thereafter permitted according to the parameters of the profiles. As may be appreciated, such a process allows a utility provider to reduce peak loads by regulating user devices. Offers to the utility provider may be in the nature of, for example, an asking price or they may be in the form of an auction to multiple providers or the Corporate Website may be programmed to represent an Aggregator role for a large number of buildings. This Aggregator role could then establish a real-time negotiation role with the Utility Company to collaborate in smoothing the peak demand curve for the Utility Company while minimizing the annual energy costs to its subscribers.

Persons skilled in the art will recognize that many modifications and variations are possible in the details, materials, and arrangements of the parts and actions which have been described and illustrated in order to explain the nature of the inventive subject matter, and that such modifications and variations do not depart from the spirit and scope of the teachings and claims contained therein.

Further, various embodiments of the inventive subject matter described herein have listed a set of features that are pertinent to the embodiment. It is noted that the exact set listed is generally for illustrative purposes and inventiveness may lie in permutations of subsets of features.

All patent and non-patent literature cited herein is hereby incorporated by references in its entirety for all purposes.

1. A computer-implemented method of managing energy usage using a general purpose computer programmed with particular software for performing the steps comprising:
identifying a plurality of n energy loads to be managed; simulating an n-dimensional configuration space comprising a control vector for each energy load based on a comfort/cost tradeoff curve for each energy load and a current cost structure; locating an optimized control n-vector in the n-dimensional configuration space based on aggregate comfort/cost; and wherein all preceding steps are executed on a computer.

2. The method of claim 1 further comprising:
characterizing the plurality of energy loads using a best-fit load profile selected from a plurality of aggregate load profiles comprising a set of rules for calculating an initial value for each load; and wherein the locating an optimized control vector comprises a recursive optimization method using an initial n-vector based on the plurality of best-fit load profiles for each energy load.

3. The method of claim 1 further comprising calculating the comfort/cost tradeoff curve using a latent variable model.

4. The method of claim 3 wherein the latent variable model comprises answers to yes/no questions as manifest variables.

5. The method of claim 1 further comprising calculating the optimal control vector using meta-heuristic optimization methods.

6. The method of claim 1 further comprising calculating the optimal control vector using a Particle Swarm Optimization (PSO) method.

7. The method of claim 1 further comprising calculating the optimal control vector using an Ant Colony Optimization (ACO) method.

8. The method of claim 6 further comprising calculating the optimal control vector using a refinement of the Particle Swarm Optimization method which incorporates predator-prey pursuit equations referred herein as the Irving-Wolfhound method.

9. A computer-implemented method of forecasting energy costs using a general purpose computer programmed with particular software for performing the steps comprising:
identifying, on a computer, a plurality of energy loads, each energy load having a maximum energy usage and a cost for every level of energy usage between zero and the maximum energy usage and the plurality of energy loads having an a maximum aggregate energy usage; simulating a cost/usage probability surface comprising a probability of a given cost for a given level of energy usage by the energy load for from zero to the cost of the maximum energy usage based on the current rate structure; and wherein all preceding steps are executed on a computer.

10. The method of claim 9 further comprising:
calculating a cost/comfort probability surface based on a comfort/cost tradeoff curve for each energy load on the computer for costs less than the maximum cost and a maximum likely cost for each load using the cost/usage probability surface based on a given a confidence level of probability and the maximum usage;
simulating an n-dimensional configuration space comprising a control vector for each energy load using the computer; and locating an optimized n-vector in configuration space based on the cost/comfort probability surface using the computer.

11. A computer-implemented method of managing energy usage using a general purpose computer programmed with particular software for performing the steps comprising:
identifying a plurality of n energy loads to be managed on a computer, each energy load having a comfort curve for each energy load on the computer comprising one or more dynamic variables; calculating a predicted comfort/cost curve based on a predicted probability distribution for each of the n energy loads;
simulating an n-dimensional configuration space comprising a control vector for each energy load using the computer; and identifying an optimized n-vector in configuration space based on the predicted comfort/cost curve; and wherein all preceding steps are executed on a computer.

12. The method of claim 11 wherein there are two or more dynamic variables and at least one of the dynamic variables is not linearly independent of the other dynamic variables.

13. A computer-implemented method of building a comfort/cost curve using a general purpose computer programmed with particular software for performing the steps comprising:
identifying a plurality energy loads to be managed, each energy load having one or more control parameters that affect energy usage, one or more output parameters that affect comfort, and a comfort/cost tradeoff curve; simulating an n-dimensional configuration space comprising a control vector for each energy load using the computer; identifying an optimized position in the configuration space based on aggregate comfort/cost; and wherein all preceding steps are executed on a computer.

14. A computer-implemented method of managing energy usage using a general purpose computer programmed with particular software for performing the steps comprising:
identifying a plurality of n energy loads to be managed; simulating an n-dimensional configuration space comprising a control vector for each energy load based on a comfort tradeoff function for each energy load and an aggregate cost structure based on total usage; locating an optimized control vector in the n-dimensional configuration space based on aggregate comfort/cost; and wherein all preceding steps are executed on a computer.

15. The method of claim 1 further comprising outputting the optimized control vector to each individual load wherein the load implements the portion of the control vector.

16. The method of claim 1 wherein the n-dimensional configuration space further comprises a control vector for one or more devices that do not impose an ongoing energy load but affect comfort.

17. The method of claim 16 wherein the one or more devices that do not impose an ongoing energy load but affect comfort comprises a remotely controlled heating register.

18. The method of claim 1 wherein the plurality of n energy loads is physically located in a single structure.

19. The method of claim 1 wherein the plurality of n energy loads is physically located in different structures.

20. The method of claim 18 wherein the optimal control vector solution is aided through the development of customized energy dynamics model of the particular structure.

21. The method of claim 20 wherein the customized energy dynamics model of the particular structure is developed via an artificial intelligence learning method utilizing live data gathered from the energy consumption and environmental factors of the structure.

22. The method of claim 21 wherein the learning method for developing the customized energy dynamics model of a particular structure utilizes a best-fit approach utilizing either PSO or ACO optimization methods.

23. The method of claim 21 wherein the learning method for developing the customized energy dynamics model of a particular structure utilizes a neural network method.

24. The method of claim 18 wherein the calculation of the optimal control vector solution is accelerated by the classification of the particular structure into one of a few energy dynamic archetypes.

25. The method of claim 24 wherein the development of a set of energy dynamic archetypes is determined using multi-dimensional scaling method for determining the minimal number of dimensions for acceptable archetype discrimination.

26. The method of claim 24 wherein the method for determining an effective number of energy dynamic archetypes uses a cluster analysis method.

27. The method of claim 24 wherein the method for determining an effective number of energy dynamic archetypes uses a discriminant function method.

28. The method of claim 24 wherein the method for determining which of the few energy dynamic archetypes a particular structure belongs uses a discriminant function method.

29. The method of claim 1 wherein the optimal control vector is optimized aggregating over a 24 hour period.

30. The method of claim 1 wherein the optimal control vector is improved by using a local weather forecast and modeling its impact on the energy usage loads of each structure.

31. The method of claim 1 wherein the optimal control vector is improved by using a forecast of the dynamic rate changes of the local utility service for each structure.

32. A remote wireless thermostat that sends temperature data to software on a local PC or microprocessor with a user interface that enables identifying the room location of the thermostat, said feature allowing the remote wireless thermostat to be moved from room to room depending upon the usage style or to enable a building specific energy dynamics model learning process.

33. Machine executable instructions stored on computer readable medium with instructions for carrying out the method of claim 1.

34. A computer system comprising a processor and memory embodying the executable instructions of claim 33.

35. A computer implemented method for a two party negotiation between aggregator and utility, comprising:
determining bids based on an aggregator's assembled user resource allocation limitation preferences as modified by aggressiveness factors in comfort/convenience sacrifice.

36. The method of claim 35 further comprising multiple back and forth bids and counter bids between aggregator and utility.

37. The method of claim 35 wherein the bid from the aggregator is improved by using a local weather forecast and modeling its impact on the forecasted energy usage loads of each structure.

38. The method of claim 35 wherein the bid from the aggregator is improved by using a forecast of the dynamic rate changes of the local utility service for each structure in particular forecasting the point in time at which the utility would invoke its demand-response terms.

39. The method of claim 35 wherein the bid from the aggregator is compliant with a demand-response contract with the utility service provider.

40. The method of claim 35 wherein the bid from the aggregator is based on bids from all participating structures under contract to the aggregator for representation to the utility company.

41. The method of claim 40 wherein bids from the participating structures to the aggregator are automated via a demand-response aggressiveness function implemented in software in a PC local to each respective structure.

42. The method of claim 40 wherein the optimal control vector for each participating structure is determined by the aggregator to maximize compliance with the demand-response contract with the utility service within the constraints of the demand-response aggressiveness functions of each participating structure.

43. The method of claim 42 wherein the optimal control vector for each participating structure uses a PSO method for solution.

44. The method of claim 42 wherein the optimal control vector for each participating structure uses the extended PSO method which integrates predator-prey pursuit equations (referred to herein as the Irving-Wolfhound PSO approach).

45. The method of claim 44 wherein the optimal control vector for each participating structure uses the Irving-Wolfhound PSO approach to solve for the optimal control vectors for each participating structure based on a forecasted weather profile (vs. time), a forecasted energy usage load for all demands on the utility provider and a forecasted rate profile (vs. time) for the utility provider.

46. The method of claim 45 wherein the forecasted usage load demands on the utility provider is based on forecasts determined by actual usage data from the participating structures, forecasted usage of the participating structures based on their lifestyle patterns and comfort-cost value functions, and extrapolation of the usage load of the participating structures to all structures served by the utility service provider.

47. The method of claim 46 wherein the forecasted usage load of non-participating structures is made more accurate by breaking the forecast down into sub-forecasts by energy dynamics structure classification categories.

48. The method of claim 35 wherein the aggregator allocates savings in the form of rebates resulting from successful bids to user's accounts based on user's aggressiveness factors.

49. The method of claim 35 wherein the negotiations are time structured meaning that the process is repeated on a regular time increment.

50. Machine executable instructions stored on computer readable medium for carrying out the method of claim 35.

51. A computer system comprising a processor and memory embodying the software of claim 50 or controlled by or controlling systems and devices embodying such software.

52. A method comprising performing an auction wherein there are multiple aggregators bidders;
wherein the auction is based on respective assembled user resource allocation limitation preferences modified by aggressiveness factors; and
wherein bids are calculated to meet or exceed contract terms for their respective demand compliance agreements with utilities.

53. The method of claim 52 wherein the auction has one aggregator and two or more utilities.

54. The method of claim 52 wherein the bidding is automatic

55. The method of claim 52 wherein the bidding is “owner decision authorized” bidding utilizing direct communication with user.

56. The method of claim 52 wherein an auction model is based on a VCG model with a balanced budget option.

57. The method of claim 56 wherein VCG model is computed on a central computer.

58. The method of claim 52 wherein the auctions are time structured meaning that the process is repeated on a regular time increment.

59. The method of claim 58 wherein the time increment is between about one hour and 72 hours.

60. The method of claim 52 wherein aggregators bid with two or more utilities. (two way auction)

61. The method of claim 52 wherein the aggregator allocates savings in the form of rebates resulting from successful bids to user's accounts based on user's aggressiveness factors.

62. The method of claim 52 wherein the bid from the aggregator is improved by using a local weather forecast and modeling its impact on the energy usage loads of each structure.

63. The method of claim 52 wherein the bid from the aggregator is improved by using a forecast of the dynamic rate changes of the local utility service for each structure.

64. The method of claim 52 wherein the bid from the aggregator is compliant with a demand-response contract with the utility service provider.

65. The method of claim 52 wherein the bid from the aggregator is based on bids from all participating structures under contract to the aggregator for representation to the utility company.

66. The method of claim 65 wherein bids from the participating structures to the aggregator are automated via a demand-response aggressiveness function implemented in software in a PC local to each respective structure.

67. The method of claim 65 wherein the optimal control vector for each participating structure is determined by the aggregator to maximize compliance with the demand-response contract with the utility service within the constraints of the demand-response aggressiveness functions of each participating structure.

68. The method of claim 67 wherein the optimal control vector for each participating structure uses a PSO method for solution.

69. The method of claim 67 wherein the optimal control vector for each participating structure uses the extended PSO method which integrates predator-prey pursuit equations (referred to herein as the Irving-Wolfhound PSO approach).

70. The method of claim 69 wherein the optimal control vector for each participating structure uses the Irving-Wolfhound PSO approach to solve for the optimal control vectors for each participating structure based on a forecasted weather profile (vs. time), a forecasted energy usage load for all demands on the utility provider and a forecasted rate profile (vs. time) for the utility provider.

71. The method of claim 70 wherein the forecasted usage load demands on the utility provider is based on forecasts determined by actual usage data from the participating structures, forecasted usage of the participating structures based on their lifestyle patterns and comfort-cost value functions, and extrapolation of the usage load of the participating structures to all structures served by the utility service provider.

72. The method of claim 71 wherein the forecasted usage load of non-participating structures is made more accurate by breaking the forecast down into sub-forecasts by energy dynamics structure classification categories.

73. Machine executable instructions stored on computer readable medium for carrying out the method of claim 52.

74. A computer system comprising a processor and memory embodying the software of claim 73.
